(19) United States
(12) Patent Application Publication
(10) Pub. No.: US 2007/0034463 A1
(43) Pub. Date: Feb. 15, 2007

(54) Control Structure for a Shock Absorber

(76) Inventor: Tan-Cheng HUANG, Taichung (TW)

Correspondence Address: BANGER SHIA, 204 CANYON CREEK, VICTORIA, TX, 77901, US

(21) Appl. No.: 11/463,592

(22) Filed: Aug. 10, 2006

(30) Foreign Application Priority Data
Aug. 12, 2005 (TW) 094127651
Oct. 25, 2005 (TW) 094137361

(51) Int. Cl. F16F 9/32

(52) U.S. Cl. 188/300

(57) ABSTRACT

A control structure for a shock absorber that comprises: a base, a control assembly, and a moving assembly. The control assembly controls the motion of the moving assembly and is moved by a steel cable. A control member and a returning spring of the control assembly serve to control the motion of the moving assembly. The steel cable drives the control member to move, and the returning spring provides an elastic force for returning the relative components to their original positions. The shock absorber is defined with a working space for reception of the moving assembly. The moving assembly is provided with sliding members, and is formed with slopes form cooperating with the sliding members. When the control member drives the moving assembly to move, the pushing member of the moving assembly will push the sliding members from the deep portion to the shallow portion of the moving member, thus making the pushing rod move.

### BACKGROUND OF THE INVENTION

1. Field of the Invention

The present invention relates to a control structure for a shock absorber that comprises: a base, a control assembly, and a moving assembly. The control assembly controls the motion of the moving assembly and is moved by a steel cable. A control member and a returning spring of the control assembly serve to control the motion of the moving assembly. The steel cable drives the control member to move, and the returning spring provides an elastic force for returning the relative components to their original positions. The shock absorber is defined with a working space for reception of the moving assembly. The moving assembly is provided with sliding members, and is formed with slopes form cooperating with the sliding members. When the control member drives the moving assembly to move, the pushing member of the moving assembly will push the sliding members from the deep portion to the shallow portion of the moving member, thus making the pushing rod move.

2. Description of the Prior Art

Currently, there are many vehicle shock absorbers, especially a bicycle should have the buffer function, and the buffer function can be turned on/off freely, so that the user can turn off the buffer function when riding up a slope, otherwise, the shock absorber will increase the resistance to the pedaling force applied by the user, and can turn off the buffer function of the front absorber when riding down a slope, otherwise, the up-and-down motion of the shock absorber will change the front tilt angle of the bike, thereby, there is a danger of falling over. However, the current shock absorber still has the following disadvantages:

Firstly, the structure for turning on/off the shock absorber is usually provided with an eccentric control shaft. When switching the buffer function of the shock absorber by pushing the pushing rod of the shock absorber with the eccentric control shaft, the control shaft should rotate at a great angle in order to get a travel that should be long enough to switch the buffer function of the shock absorber, further, the control shaft will produce a relatively great friction when rotating within the control hole of the control body.

Secondly, for the current bicycle's shock absorber, the damping force should be adjusted according to the real condition of a road, however, it also needs to rotate at a comparatively large angle when adjusting the shock absorber, thereby causing inconvenience to the user.

The present invention has arisen to mitigate and/or obviate the afore-described disadvantages.

### SUMMARY OF THE INVENTION

The primary objective of the present invention is to provide a control structure for a shock absorber, wherein a low resistant control member is used to drive the pushing rod of the shock absorber to move, when the control member drives the moving assembly to move, the pushing member of the moving assembly will push the sliding members from the deep portion to the shallow portion of the moving member, thus making the pushing rod move.

Another objective of the present invention is to provide a control structure for a shock absorber, wherein the rolling movement of the sliding members is used to reduce the friction force between the components, the sliding members are driven by the pushing member to roll along the slope of the moving assembly, thus driving the pushing rod to move, in this way, the buffer function of the shock absorber is switched. Therefore, the control structure for a shock absorber will not produce a friction force as great as that produced by the existing shock absorber.

The third objective of the present invention is to provide a control structure for a shock absorber, wherein the pushing rod can drive the pushing rod of the shock absorber to move a long distance (long travel). The sliding members are disposed at both sides of the pushing member, when the control assembly drives the pushing member to move, the first sliding member and the second sliding member will move between the deep portion and the shallow portion of the first slope and the second slope. The first sliding member drives the pushing member and the second sliding member to move, meanwhile, the slope of the moving assembly drives the second sliding member to move, therefore, the movement of the pushing member can make the pushing rod move a long travel length, allowing the user to switch the buffer function quickly and laborsavingly.

A control structure for a shock absorber installed at a side of the shock absorber, the shock absorber provided with a pushing for switching buffer function of the shock absorber, the control structure comprising: a base, a control assembly, and a moving assembly, the control assembly serving to control the moving member;

A pushing member of the moving assembly is driven to move by the control assembly, a sliding member of the moving member is located beside the pushing member, the moving assembly is formed with a slope for cooperating with the sliding member, when the pushing member moves, the sliding member will be caused to move between a deep portion and a shallow portion of the slope to drive the pushing rod of the shock absorber to move, switching the buffer function of the shock absorber.

A receiving groove is formed in a side of the pushing rod of the shock absorber, and an abutting surface is formed at a bottom of the receiving groove.

The control assembly and the moving assembly are installed on the based, the control assembly controls the moving assembly.

The control assembly includes a control member and a returning spring, a side of the control member is connected to a steel cable, the returning spring provides an elastic force for returning relative components to their original positions.

The moving assembly includes a positioning member, a pushing member, a first sliding member, and a second member, the positioning member is formed with a receiving groove, an abutting surface is formed at the bottom of the receiving groove, the pushing member is formed with a first slope located correspondingly to the receiving groove of the positioning member, the first slope includes a deep portion and a shallow portion, a second slope is formed on the pushing member and is located correspondingly to the receiving groove of the pushing rod and includes a deep portion and a shallow portion.

The first sliding member is received in the receiving groove of the positioning member in a such manner that one end of the first sliding member abuts against the abutting surface of the receiving groove, and the other end of the first sliding member abuts against the first slope of the pushing member.

The second sliding member is received in the receiving groove of the positioning member in a such manner that one end of the second sliding member abuts against the abutting surface of the receiving groove, and the other end of the first sliding member abuts against the second slope of the pushing member, when the control assembly drives the pushing member to move, the first sliding member and the second sliding member will move between the deep portion and the shallow portion of the first slope and the second slope.

### BRIEF DESCRIPTION OF THE DRAWINGS

FIG. 1 is an exploded view of a control structure for a shock absorber in accordance with a first embodiment of the present invention;

FIG. 2 is a cross section operational view of the control structure for a shock absorber in accordance with the first embodiment of the present invention;

FIG. 3 is cross section operational view taken along the line A-A of FIG. 2;

FIG. 4 is another cross section operational view taken along the line B-B of FIG. 2;

FIG. 5 is another cross section operational view of the control structure for a shock absorber in accordance with the first embodiment of the present invention;

FIG. 6 is cross section operational view taken along the line A-A of FIG. 5;

FIG. 7 is another cross section operational view taken along the line B-B of FIG. 5;

FIG. 8 is an exploded view of a control structure for a shock absorber in accordance with a second embodiment of the present invention;

FIG. 9 is a cross sectional view of the control structure for a shock absorber in accordance with the second embodiment of the present invention;

FIG. 10 is a top view of the control structure for a shock absorber in accordance with the second embodiment of the present invention;

FIG. 11 is a cross sectional view of the control structure for a shock absorber in accordance with the second embodiment of the present invention;

FIG. 12 is a cross section operational of the control structure for a shock absorber in accordance with the second embodiment of the present invention;

FIG. 13 is another cross section operational of the control structure for a shock absorber in accordance with the second embodiment of the present invention;

FIG. 14 is an exploded view of a control structure for a shock absorber in accordance with a third embodiment of the present invention;

FIG. 15 is a cross section operational of the control structure for a shock absorber in accordance with the third embodiment of the present invention;

FIG. 16 is a cross section view taken along the line of A-A of FIG. 15;

FIG. 17 is another cross section operational of the control structure for a shock absorber in accordance with the third embodiment of the present invention;

FIG. 18 is a cross section view taken along the line of A-A of FIG. 17;

FIG. 19 is an exploded view of a control structure for a shock absorber in accordance with a fourth embodiment of the present invention;

FIG. 20 is a cross section operational of the control structure for a shock absorber in accordance with the fourth embodiment of the present invention;

FIG. 21 is a cross section view taken along the line of A-A of FIG. 20;

FIG. 22 is another cross section operational of the control structure for a shock absorber in accordance with the fourth embodiment of the present invention;

FIG. 23 is a cross section view taken along the line of A-A of FIG. 22;

FIG. 24 is an exploded view of a control structure for a shock absorber in accordance with a fifth embodiment of the present invention;

FIG. 25 is a cross section operational of the control structure for a shock absorber in accordance with the fifth embodiment of the present invention;

FIG. 26 is an exploded view of a control structure for a shock absorber in accordance with a sixth embodiment of the present invention;

FIG. 27 is a top view of the control structure for a shock absorber in accordance with the sixth embodiment of the present invention;

FIG. 28 is a cross sectional view of the control structure for a shock absorber in accordance with the sixth embodiment of the present invention;

FIG. 29 is an exploded view of a control structure for a shock absorber in accordance with a seventh embodiment of the present invention;

FIG. 30 is a cross section operational of the control structure for a shock absorber in accordance with the seventh embodiment of the present invention;

FIG. 31 is a cross section view taken along the line of A-A of FIG. 29;

FIG. 32 is an exploded view of a control structure for a shock absorber in accordance with an eighth embodiment of the present invention;

FIG. 33 is a cross section operational of the control structure for a shock absorber in accordance with the eighth embodiment of the present invention;

FIG. 34 is another cross section operational of the control structure for a shock absorber in accordance with the eighth embodiment of the present invention;

FIG. 35 is an exploded view of a control structure for a shock absorber in accordance with a ninth embodiment of the present invention;

FIG. 36 is a cross section operational of the control structure for a shock absorber in accordance with the ninth embodiment of the present invention;

FIG. 37 is a cross section view taken along the line of A-A of FIG. 35;

FIG. 38 shows another embodiment of the mounting member in accordance with the second embodiment of the present invention;

FIG. 39 shows the positions of the assistant sliding members relative to the mounting member in accordance with the fourth embodiment of the present invention;

FIG. 40 shows another embodiment of the mounting member in accordance with the fourth embodiment of the present invention;

FIG. 41 shows the positions of the assistant sliding members relative to the mounting member in accordance with the fourth embodiment of the present invention;

FIG. 42 shows another embodiment of the mounting member in accordance with the sixth embodiment of the present invention;

FIG. 43 shows the positions of the assistant sliding members relative to the mounting member in accordance with the sixth embodiment of the present invention;

FIG. 44 shows another embodiment of the mounting member in accordance with the seventh embodiment of the present invention;

FIG. 45 shows the positions of the assistant sliding members relative to the mounting member in accordance with the seventh embodiment of the present invention;

FIG. 46 shows another embodiment of the mounting member in accordance with the eighth embodiment of the present invention;

FIG. 47 shows the positions of the assistant sliding members relative to the mounting member in accordance with the eighth embodiment of the present invention;

FIG. 48 shows another embodiment of the mounting member in accordance with the ninth embodiment of the present invention; and

FIG. 49 shows the positions of the assistant sliding members relative to the mounting member in accordance with the ninth embodiment of the present invention.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

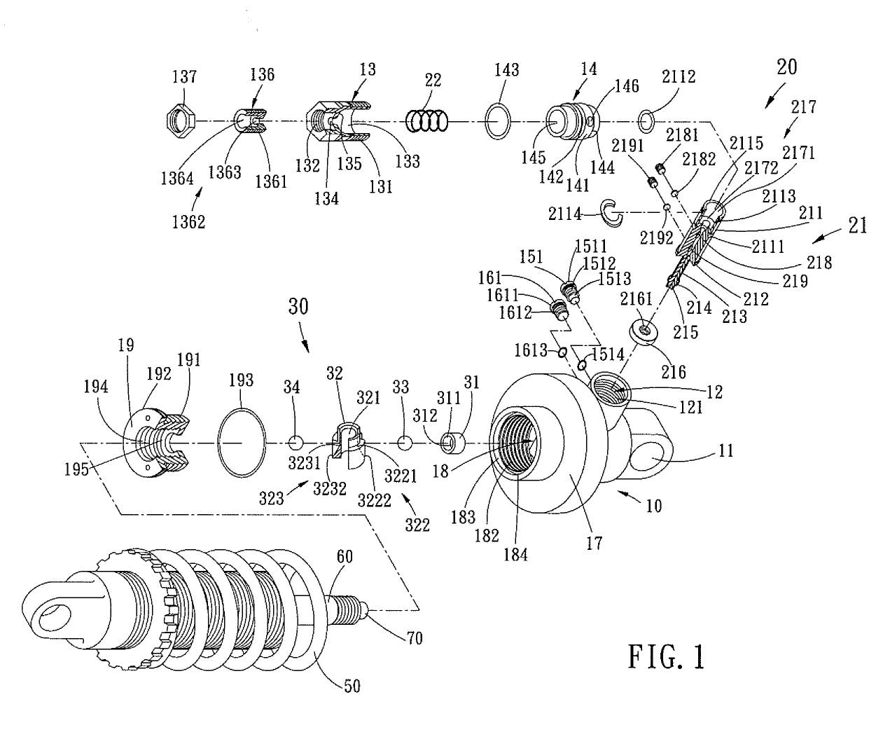

Referring to FIGS. 1-7, a control structure for a shock absorber in accordance with the present invention comprises: a base 10, a control assembly 20 and a moving assembly 30.

The base 10 is formed at an end thereof with a pivoting hole 11 to be connected to the body of a bicycle or vehicle, and a control hole 12 is defined beside the pivoting hole 11 and extends into the interior of the base 10. A plurality of inner threads 121 is formed in the control hole 12 and is located close to the base 10. Formed next to the threads 121 is a positioning surface 122. A thread insert 13 with outer threads 131 is screwed in the control hole 12 of the base 10 in such a manner that a side of the thread insert 13 protrudes out of the outer edge of the control hole 12 of the base 10. A threaded hole 132 is formed in the side of the thread insert 13 that protrudes out of the base 10, and an inner hole 133 is formed in another side of the thread insert 13 opposite the threaded hole 132. The threaded hole 132 and the inner hole 133 are connected by the through hole 134. The annular connecting portion between the inner hole 133 and the through 134 is a positioning surface 135. An adjusting bolt 136 is screwed in the threaded hole 132 of the thread insert 13, and a plurality of outer threads 1361 is formed on the outer surface of the adjusting bolt 136 for meshing with a positioning nut 137, so that the adjusting screw 136 is fixed at the end of the thread insert 13 by the positioning nut 137. The adjusting screw 136 is defined with a stepped hole 1362 whose small inner hole 1363 is provided for insertion of steel cable 40, and the large inner hole 1364 is provided for insertion of a cable encasing tube 41. A sleeve 14 is disposed in the control hole 12 of the base 10 and is located adjacent to the thread insert 13. A flange 141 is formed on the outer periphery of the sleeve 14, and formed in the outer surface of the flange 141 is an annular groove 142 in which is received a sealing ring 143. The sleeve 14 is hermetically inserted in the control hole 12 of the base 10 by the sealing ring 143, and the inner surface 144 of the flange 141 is positioned on the positioning surface 122 of the control hole 12 of the base 10, and the sleeve 14 is fixed in the control hole 12 of the base 10 by the thread insert 13. An axial through hole 145 is defined in the sleeve 14, and a positioning hole 146 is formed in the outer surface of the sleeve 14.

A threaded positioning hole 15 is formed in the base 10 and is located correspondingly to the positioning hole 146 of the sleeve 14. A positioning screw 151 is screwed in the threaded hole 15 and has a flange 1511 and a plurality of outer threads 1512. An annular positioning surface 1513 is formed on the outer periphery of the positioning screw 151 and is located next to the outer threads 1512 thereof A sealing ring 1514 is located next to the flange 1511. The positioning screw 151 is screwed in the threaded positioning hole 15 of the base 10 in such a manner that the annular positioning surface 1513 is inserted in the positioning hole 146 of the sleeve 14, and thus the sleeve 14 is confined in the control hole 12 of the base 10. The base 10 is further defined with a threaded hole 16 that is formed beside the threaded positioning hole 15 and is located correspondingly to the control hole 12. A sealing screw 161 is screwed in the threaded hole 16 and has a flange 1611 and a plurality of outer threads 1612. A sealing ring 1613 is located beside the flange 1611.

An abutting surface 17 is formed on the outer surface of the base 10 and is located beside the pivoting hole 11. The abutting surface 17 is to be pressed against the shock-absorbing spring 50. A working space 18 is formed inside the base 10, and a receiving groove 181 is formed in the bottom of the working space 18. The control hole 12 is in communication with the working space 18. A plurality of inner threads 182 and an expanding hole 183 are formed in the working space 18 and are located close to the outer end thereof A positioning surface 184 is formed at the bottom of the enlarging hole 183. The inner threads 182 are to be screwed with an annular thread insert 19 having a plurality of outer threads 191 and a flange 192. A sealing ring 192 is disposed beside the flange 192. The outer threads 191 are to be meshed with the inner threads 182 of the working space 18. The flange 192 and the sealing ring 193 are sealed in the enlarging hole 183 and are positioned on the positioning surface 184 thereof. The annular thread insert 19 is defined with a threaded hole 194 and a positioning surface 194 formed at the bottom of the threaded hole 194. A shaft 60 of the shock absorber is screwed in the threaded hole 194 and positioned against the positioning surface 195. A pushing rod 70 inside the shaft 60 is inserted into the working space 18. A receiving groove 71 is formed in an end of the pushing rod 70, and an abutting surface 72 is formed at the bottom of the receiving groove 71.

The control assembly 20 includes a control member 21 and a returning spring 22.

The control member 21 includes a first outer diameter 211, and an annular groove 2111 is formed in the outer surface of the outer diameter 211 for reception of a sealing ring 2112. The first outer diameter 211 and the sealing ring 2112 of the control member 21 are moveably sealed in the through hole 145 of the sleeve 14 in the control hole 12 of the base 10. A side of the first outer diameter 211 protrudes out of the outer end surface of the sleeve 14, and an engaging groove 2113 is formed in the outer diameter 211 protruding out of the sleeve 14 for reception of a fastener 2114. The outer end surface of the first outer diameter 211 of the control member 21 is a positioning surface 2115 that is to be pushed against the positioning surface 135 of the thread insert 13 when the control member 21 slides to a predetermined position in the through hole 145 of the sleeve 14. The control member 21 is to be positioned on the outer end surface of the sleeve 14 when the control member 21 slides to the predetermined position in the through hole 145 of the sleeve 14.

The control member 21 is formed with a first flange 212 located beside the first outer diameter 211. A second outer diameter 213 is beside the first outer diameter 212. A second flange 214 is located beside the second outer diameter 213, and located next to the second flange 214 is a riveting portion 215. A connecting member 216 is formed with a stepped hole 2161 for reception of the second flange 214 of the control member 21 and the riveting portion 215, so that the connecting member 216 and the control member 21 are connected together by riveting. The control member 21, the first flange 212, the second outer diameter 213 and the connecting member 216 extend into the working space 18 of the base 10 and move therein.

The control member 21 is further defined with a receiving hole 217 and an expanding hole 2171 formed in the receiving hole 217 and located close to the outer end thereof. The expanding hole 2171 is formed at its bottom with an abutting surface 2172. A first threaded positioning hole 218 and a second threaded positioning hole 219 are formed in the outer periphery of the control member 21 and are located correspondingly to the threaded positioning hole 15 and the threaded hole 16 of the base 10. A positioning screw 2181, 2191 and a washer 2182, 2192 are received in each of the first and second threaded positioning holes 218 and 219. The steel cable 40 is inserted in the receiving hole 217 and is fixed therein by the positioning screws 2181, 2191 and the washers 2182, 2192.

The returning spring 22 is installed in the expanding hole 2171 of the control member 21 and is biased between the abutting surface 2172 of the expanding hole 2171 and the abutting surface 135 of the thread insert 13.

The moving assembly 30 is installed in the working space 18 of the base 10 and is controlled by the control member 21 of the control assembly 20. The moving assembly 30 includes a positioning member 31, a pushing member 32, a first sliding member 33, and a second sliding member 34. The pushing member 32 is formed on its outer surface with a slope. The positioning member 31 is formed with a receiving groove 311 and an abutting surface 312 at the bottom of the receiving groove 311. The positioning member 31 is received in the receiving groove 181 of the working space 18 of the base 10. The inner diameter 321 of the pushing member 32 is mounted on the second outer diameter 213 of the control member 21 in such a manner that both end surfaces of the pushing member 32 are slideably received between the first flange 212 of the control member 21 and the connecting member 216. An interval is left between the inner diameter 321 of the pushing member 32 and the second outer diameter 213 of the control member 21, for allowing the pushing member 32 to move a predetermined distance along the second outer diameter 213. The pushing member 32 is confined between the first flange 212 of the control member 21 and the connecting member 216 when moving in the control member 21, and the control member 21 controls the motion of the pushing member 32. The pushing member is formed on its outer surface facing the positioning member 31 with a slope 322 which is located correspondingly to the receiving groove 312 of the positioning member 31. The first slope 322 includes a deep portion 3221 and a shallow portion 3222. The pushing member 32 is formed on its outer surface opposite the first slope 322 with a second slope 323 which is located correspondingly to the receiving groove 71 of the pushing rod 70, and the second slope 323 includes a deep portion 3231 and a shallow portion 3232. The first sliding member 33 is received in the receiving groove 311 of the positioning member 31 in such a manner that an end of the first sliding member abuts against the bottom surface of the receiving groove 311 and another end abuts against the first slope 322 of the pushing member 32. The second sliding member 34 is received in the receiving groove 71 of the pushing rod 70 in such a manner that one end of the second sliding member 34 abuts against the second slope 323 of the pushing member 32, and another end abuts against the abutting surface 72 of the receiving groove 71 of the pushing rod 70.

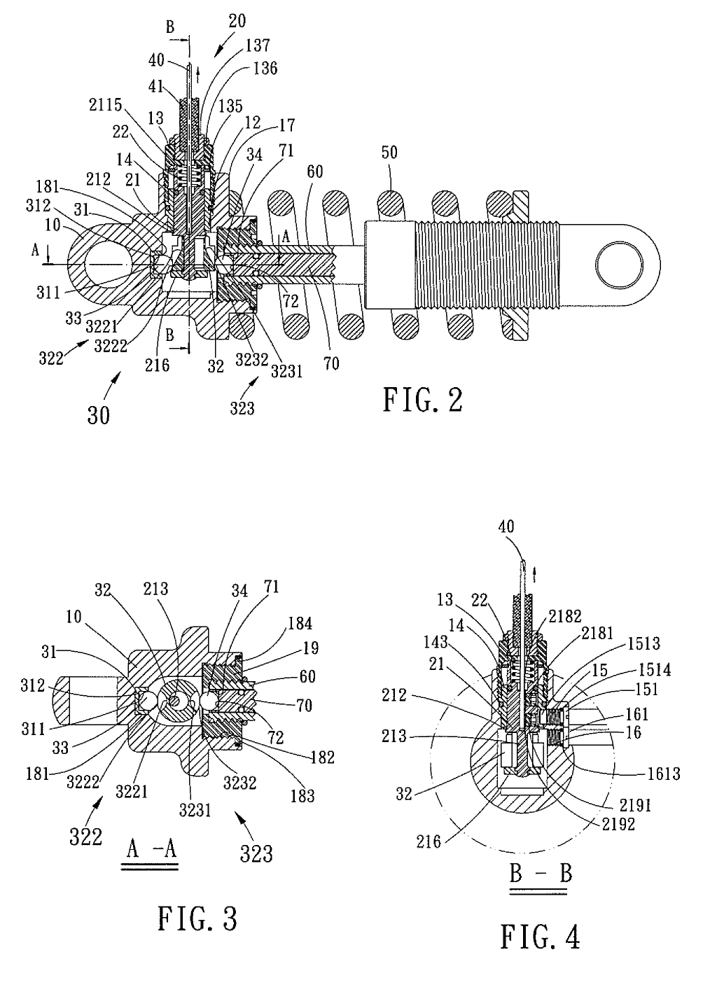

For a better understanding of the first embodiment, its operation and function, reference should be made to FIGS. 2-7.

As shown in FIGS. 2-4, when the user pulls the steel cable 40, the control member 21 of the control assembly 20 will be driven to move and the returning spring 22 will be compressed. When the control member 21 moves to a predetermined position, the positioning surface 2115 on the outer end surface of the control member 21 will abut against the positioning surface 135 of the thread insert 13. When the controlling member 21 moves, the connecting member 216 will drive the pushing member 32 of the moving assembly 30 to move (since both end surfaces of the pushing member 32 are confined and slide between the first flange 212 of the control member 21 and the connecting member 216). The movement of the pushing member 32 causes one end of the first sliding member 33 received in the receiving groove 311 of the positioning member to move from the deep portion 3221 to the shallow portion 3222 of the first slope 322 of the pushing member 32. At this moment, the other end of the first sliding member 33 abuts against the abutting surface 312 of the receiving groove 311 of the positioning member 31. Therefore, the first sliding member 33 will push the pushing member 32 toward the pushing rod 70. Meanwhile, one end of the second sliding member 34 received in the receiving groove 71 of the pushing rod 70 will move from the deep portion 3231 to the shallow portion 3232 of the second slope 323 of the pushing member 32, and the other end of the second sliding member 34 abuts against the abutting surface 72 of the receiving groove 71 of the pushing rod 70. Therefore, when the control member 21 moves the pushing member 32, the first sliding member 33 will push the pushing member and the second sliding member 34 toward the pushing rod 70. Meanwhile, the second slope 323 of the pushing member 32 is pushed toward the pushing rod 70 by the second sliding member 34, thus allowing the pushing rod 70 to move a long length (long travel) into the interior of the shock absorber and to switch the buffer function.

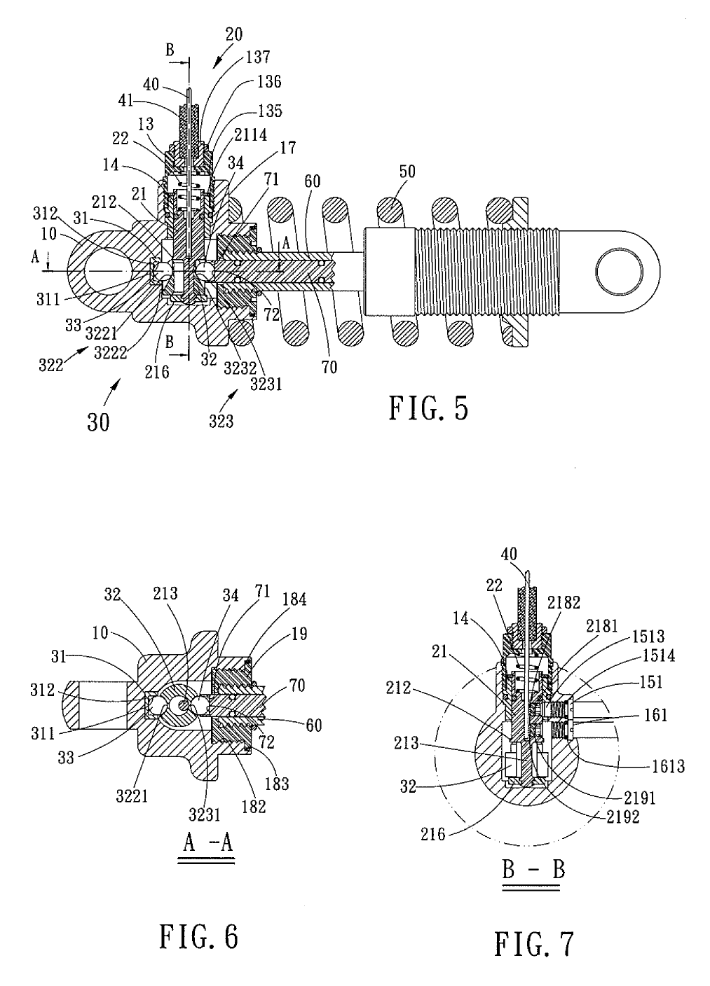

As shown in FIGS. 5-7, when the user releases the steel cable 40, the returning spring 22 of the control assembly 20 will push the control member 21 to its original position. The fastener 2114 of the control member 21 will abut against the outer end surface of the sleeve 14, meanwhile, the first flange 212 of the control member 21 will push the pushing member 32 of the moving assembly 30, the first sliding member 33 received in the receiving groove 311 of the positioning member 31 will be moved from the deep portion 3221 to the shallow portion 3222 of the first slope 322 of the pushing member 32. And the second sliding member 34 received in the receiving groove 71 of the pushing rod 70 will be moved from the shallow portion 3232 to the deep portion 3231 of the second slope 323 of the pushing member 32. As a result, the elastic force of the interior of the pushing rod 70 will push the pushing member 32 to the positioning member 31. At this moment, the pushing rod 70 will protrude out and change the buffer function of the shock absorber. Therefore, the pushing rod can move a long travel length, allowing the user to switch the buffer function quickly and laborsavingly.

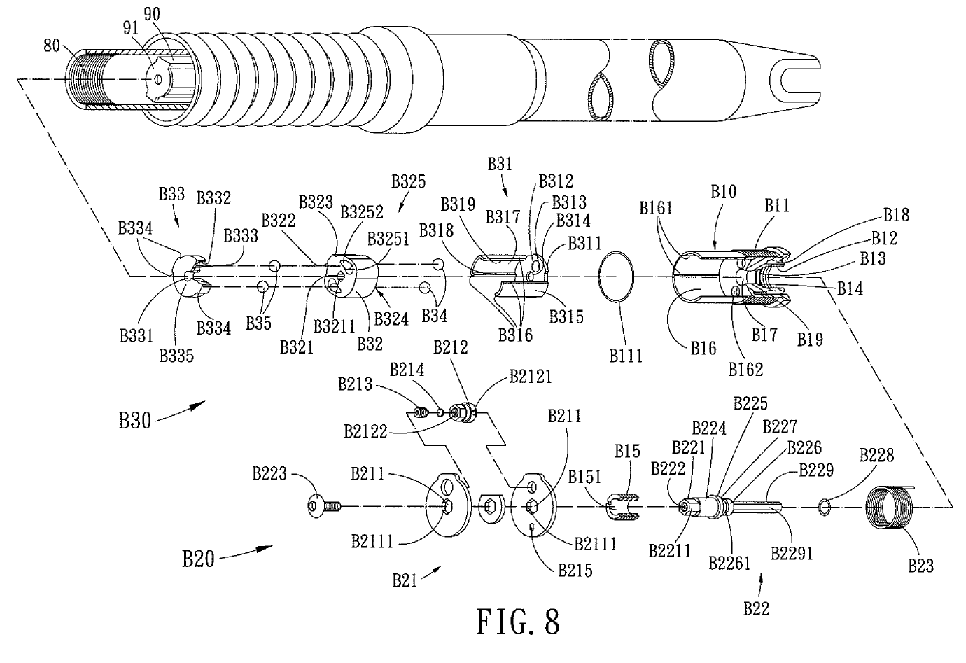

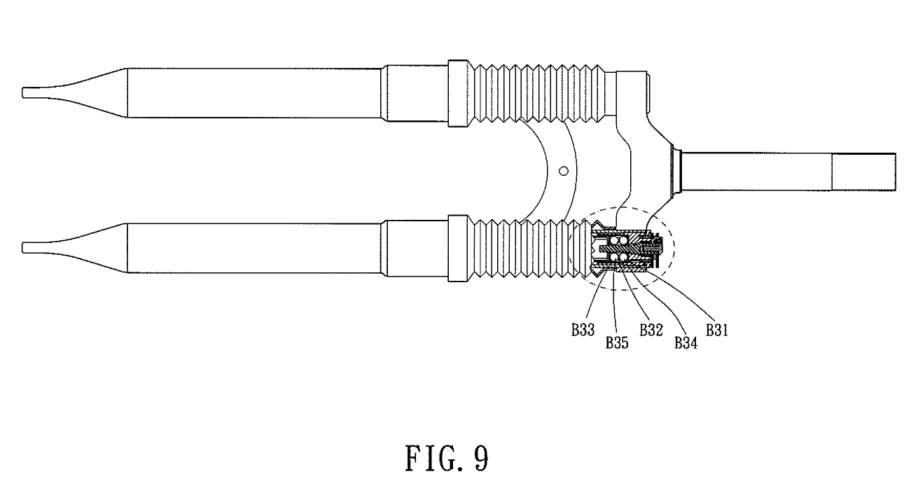

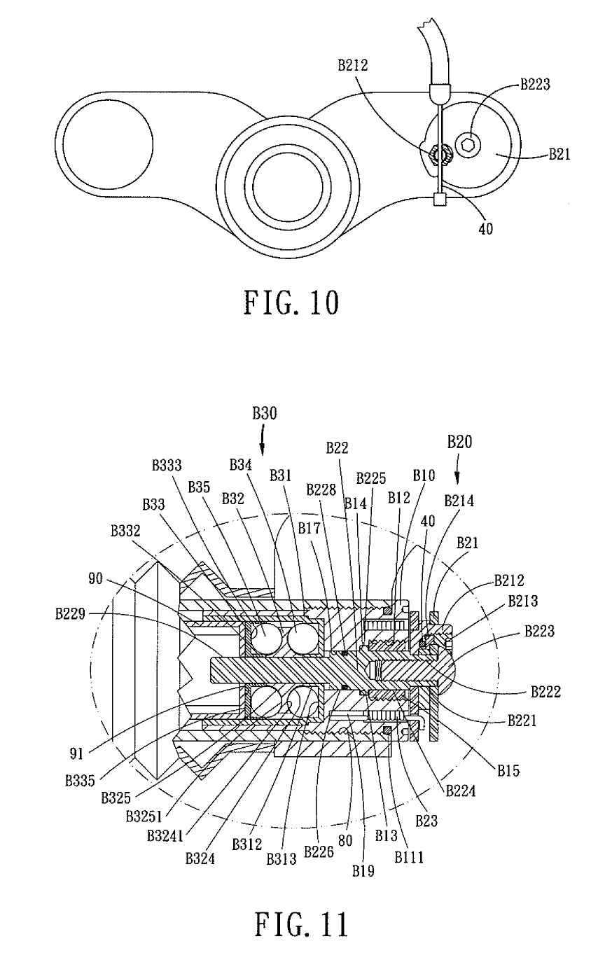

Referring to FIGS. 8-13, which show a second embodiment (the shock absorber is mounted on the front fork of the bicycle) of the present invention. The shock absorber in this embodiment also comprises: a base B10, a control assembly B20 and a moving assembly B30. The base B10 is provided with a plurality of outer threads B11 for meshing with the inner threads 80 on the top end of the shock absorber, so that the base B10 is hermetically fixed on the top end of the shock absorber by a sealing ring B111. The base B10 is formed in a side thereof with a threaded hole B12, an inner hole B13 formed in the bottom of the threaded hole B12, and a positioning surface B14 formed at the bottom of the inner hole B13.

The positioning nut B15 is formed with a through hole B151. A working space B15 is formed in the other side of the base B10, formed in the working space B15 is a positioning concave B161, and a through hole B17 is formed between the inner hole B13 and the working space B16. A receiving space B18 is formed in the base B10 and is located outside the threaded hole B12, and a plurality of inserting holes B19 for insertion of spring is formed in the bottom of the receiving space B18.

The control assembly B20 includes a drive member B21, a control member B22 and a returning spring B23.

The pushing member C32 is also positioned outside the second outer diameter 213 of the control member, and both ends of the pushing member C32 are also moveably received in the control member B22. A drive shaft B212 is disposed beside the drive hole B211 and is formed with a through hole B2121, and a threaded hole B2122 is formed beside the through hole B2121. A positioning screw B213 and a washer B214 are received in the threaded hole B2122. A steel cable 40 to be controlled by the user is inserted in the through hole B2121 and is fixed therein by the positioning screw B213 and the washer B214. The drive member B21 is formed with a through hole B215 for accommodation of spring.

The control member B22 includes a first drive outer diameter B221 which is formed with a first drive surface B2211, and a threaded hole B222 is formed in the first drive outer diameter B221. The first drive outer diameter B221 is inserted in the drive hole B211 of the drive member B21. The drive surface B2111 of the drive hole B211 cooperates with the first drive surface B2211 of the first drive outer diameter B221. A positioning screw B223 is screwed in the threaded hole B222 of the control member B22 to connect the drive member B21 with the control member B22. The control member B22 is formed on the first drive outer diameter B221 with a first step portion B224. A flange B225 is formed beside the first step portion B224, and a second step portion B226 is located next to the flange B225. The annular connecting portion between the flange B225 and the step portion B226 is a positioning surface B227. An annular groove B2261 is formed in the second step portion B226 for reception of a sealing ring B228. The control member B22 is formed with a second drive outer diameter B229 located beside the second step portion B226, and a second drive surface B2291 is formed on the second drive outer diameter B229.

The first step portion B224 of the control member B22 is moveably received in the through hole B151 of the positioning nut B15 of the base B10, the flange B225 is moveably inserted in the inner hole B13 of the base B10, and the positioning surface B227 moveably abuts against the positioning surface B14 at the bottom of the inner hole B13 of the base B10. The second step portion B226 of the control member B22 is hermetically and moveably sealed in the through hole B17 of the base B10 by the sealing ring B228. The positioning nut B15 is mounted on the first step portion B224 of the control member B22 and is screwed in the threaded hole B12 of the base B10. The front end of the positioning nut B15 slideably rests on the annular edge of the flange B225 of the control member B22, and thus the control member B22 is rotatably but immovably restricted in the base B10.

The returning spring B23 is received in the receiving space B18 of the base B10 in such a manner that one end of the returning spring B23 is inserted in any of the inserting holes B19 of the base B10 (to achieve a desired elastic force), while the other end of the returning spring B23 is hooked to the inserting hole B215 of the drive member B21.

The moving assembly B30 is movably installed in the working space B16 of the base B10 and is controlled by the control assembly B20. The moving assembly B30 includes a positioning member B31, a pushing member B32, a mounting member B33, a first sliding member B34, and a second sliding member B35. The pushing member B32 is formed on a side thereof with a slope.

The positioning member B31 is received in the working space B16 of the base B10, and the bottom B311 of the positioning member B31 rests against the bottom of the working space B16.

The positioning member B31 is formed in the bottom B311 with a receiving groove B312. An abutting surface B313 is formed on the bottom of the receiving groove B312, and a through hole B313 is formed in the inner surface of the receiving groove B312. A groove portion B315 is formed on the outer side the receiving groove B312 and extends outward. An engaging portion B316 is formed on the outside of the groove portion B315 and is positioned in the positioning concave B161 of the working space B16 of the base B10. A groove B317 is defined in the groove portion B315, and a first positioning surface B318 and a second positioning surface B319 are formed in the groove B317.

The pushing member B32 is received in the working space B16 of the base B10 and is disposed beside the positioning member B31 and is formed with a drive hole B321 in which a drive surface B3211 is defined. The second drive outer diameter B229 of the control member B22 is inserted in the drive hole B321. The second drive surface B2291 of the control member B22 cooperates with the drive surface B3211 of the pushing member B32. The pushing member B32 is driven to rotate by the control member B22. The pushing member B32 is formed on its outer surface with a first positioning portion B322 and a second positioning portion B323. The first positioning portion B322 is positioned on the first positioning surface B318 of the groove B317 of the groove portion B315 of the positioning member B31 when the pushing member B32 is not rotating. The second positioning portion B323 is positioned on the second positioning surface B319 of the groove B317 of the groove portion B315 before the pushing member B32 rotates to its final position. The pushing member B32 is formed with a first slope B324 that includes a deep portion B3241 and a shallow portion B3245 and is located correspondingly to the receiving groove B312 of the positioning member B31. The pushing member B32 is formed with a second slope B325 that includes a deep portion B3251 and shallow portion B3252 and is located opposite the first slope B324. The mounting member B33 is installed in the working space B16 of the base B10 and is disposed beside the pushing member B32 and is formed with a through positioning hole B331 that is to be slideably mounted on the second drive outer diameter B229 of the control member B22. The mounting member B33 is formed with a receiving groove B332 that is formed beside the through positioning hole B331 and is located correspondingly to the second slope B325 of the pushing member B32. An abutting surface B333 is formed at the bottom of the receiving groove B332. An engaging portion B334 is formed on the outer surface of the mounting surface B33 and is slideably received in the groove B317 of the groove portion B315 of the positioning member B31, and thus the mounting member B33 is movably but not rotatably restricted in the groove B317. A side surface B335 of the mounting member B33 abuts against the end surface 91 of the pushing rod 90.

The first sliding member B34 is received in the receiving groove B312 of the positioning member B31 in such a manner that one end of the first sliding member B34 abuts against the abutting surface B313 at the bottom of the receiving groove B312, and another end abuts against the first slope B324 of the pushing member B32. The second sliding member B35 is received in the receiving B332 of the mounting member B33 in such a manner that one end of the second sliding member B35 abuts against the abutting surface B333 at the bottom of the receiving groove B332, and another end abuts against the second slope B325 of the pushing member B32.

For a better understanding of the second embodiment, its operation and function, reference should be made to FIGS. 11-13.

As shown in FIGS. 11 and 12, when the user pulls the steel cable 40, the drive member B21 of the control assembly B20 will be driven to move. The drive member B21 will drive the control member B22 to rotate by using the drive hole B211. And then the control member B22 will use the second drive outer diameter B229 to rotate the pushing member B32 of the moving assembly B30. Meanwhile, the returning spring will be compressed. The pushing member B32 rotates, the first sliding member b34 will move from the deep portion B3241 to the shallow portion B3242 of the first slope B324 of the pushing member B32 (since the first sliding member B34 is received in the receiving groove B332 of the base B33, plus the engaging portion B334 of the mounting member B33 is slideably disposed in the groove B317 of the groove portion B315 of the positioning member B31, the second sliding member B35 will not rotate along with the pushing member B32), and the other end of the second sliding member B35 will abut against the abutting surface B333 of the receiving groove B332 of the mounting member B33. Therefore, when pushing member B32, the first sliding member B34 will push the pushing member B32, the second sliding member B35 and the mounting member B33 toward the pushing rod 90. Meanwhile, the second slope B325 of the pushing member B32 will push the second sliding member B35 to move the mounting member B33. The other end of the mounting member B33 will push the end surface 91 of the pushing rod 90, allowing the pushing rod 90 to move a long length (long travel) into the interior of the shock absorber and to switch the buffer function.

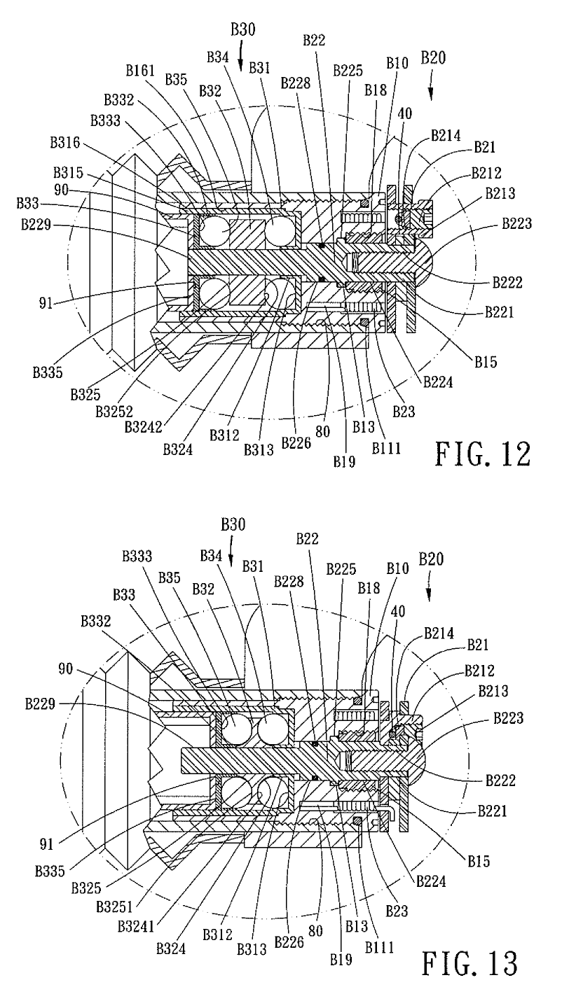

As shown in FIG. 13, when the user releases the steel cable 40, the returning spring B23 of the control assembly B20 will push the drive member B21 and the control member B22 to their original position, the second drive outer diameter B229 of the control member B22 will drive the pushing member B32 of the moving assembly B30 to rotate to its original position, and the first positioning portion B322 of the pushing member B32 will abut against the first positioning surface B318 in the groove B317 of the groove portion B315 of the positioning member B31. At this moment, the first sliding member B34 received in the receiving groove B312 of the positioning member B31 moves from the shallow portion B3242 to the deep portion B3241 of the first slope B324, and the second sliding member B35 in the receiving groove B332 of the mounting member B33 will move from the shallow portion B3252 to the deep portion B3251 of the second slope B325 of the pushing member B32. As a result, an interval will appear between the mounting member B33, the pushing member B32 and the positioning member B31, the elastic force of the interior of the pushing rod 90 will push the mounting member B33 and the pushing member B32 to the positioning member B31. At this moment, the pushing rod 90 will protrude out and change the buffer function of the shock absorber. Therefore, the pushing rod can move a long travel length, allowing the user to switch the buffer function quickly and laborsavingly.

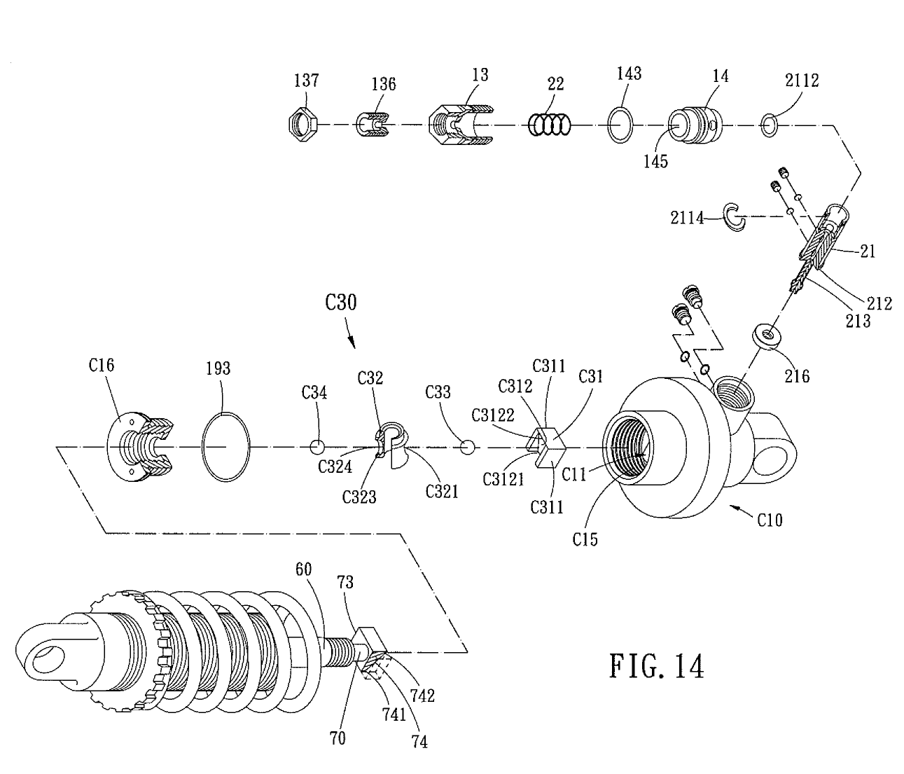

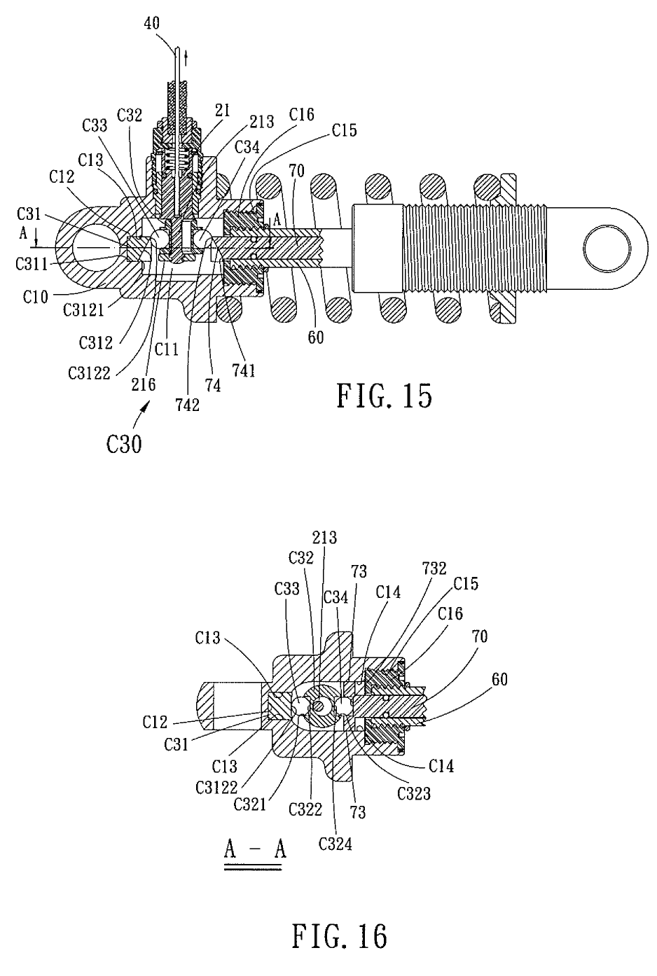

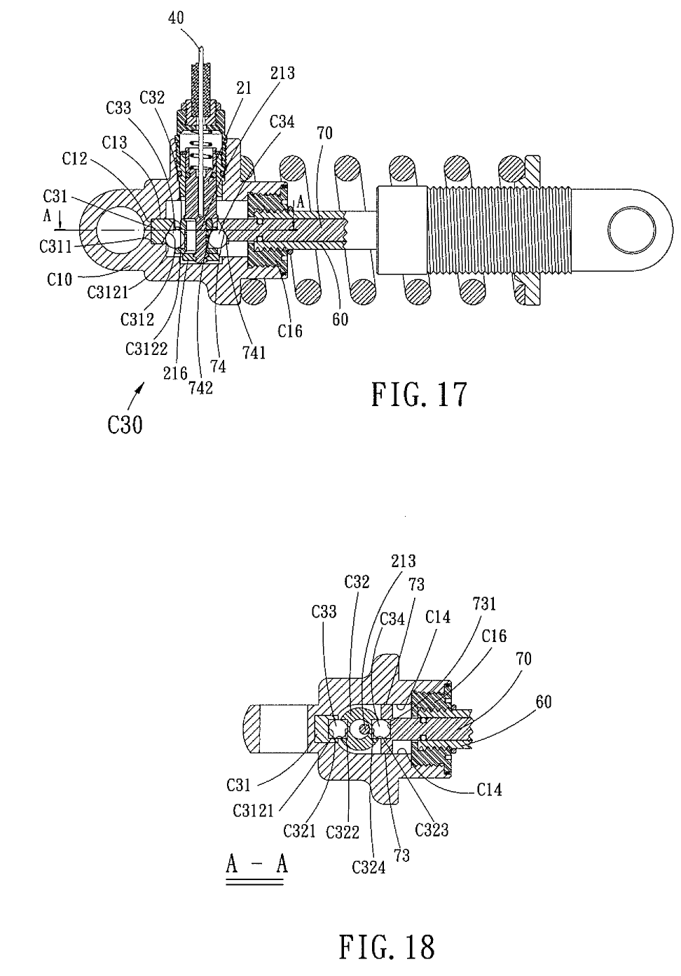

Referring to FIGS. 14-18, a third embodiment of the present invention is shown and is similar to the first embodiment except that: the receiving groove 311 in the positioning member 31 of the moving assembly 30 and the first slope 322 of the pushing member 32 have exchanged positions, and the second slope 323 of the pushing member 32 and the receiving groove 71 of the pushing rod 70 have also exchanged positions. The moving assembly is formed with a slope for cooperating with the sliding member, and is further provided with a positioning member for cooperating with the sliding member, and the pushing member or the pushing rod is formed with a slope. The rest components are identical to the first embodiment, so further explanation is omitted.

A positioning groove C12 is formed in the bottom of the working space C11 of the base C10, and a positioning surface C13 is formed in the positioning groove C12. The moving assembly 30 is disposed in the working space C11. An engaging portion C14 is formed in the working space C11, and formed beside the engaging portion C14 is a plurality of inner threads C15 for meshing with an annular thread insert C16. The annular thread insert C16 is connected to the shaft 60. The pushing rod 70 inside the shaft 60 extends into the working space C11, and the end of the pushing rod 70 extending into the working space C11 is formed with an engaging surface 73 to be slideably rested against the engaging portion C14 of the base C10, so that the pushing rod 70 is slideably but not rotatably disposed in the working space C11. This end of the pushing rod 70 is further formed with a slope 74 that includes a deep portion 741 and a shallow portion 742. The positioning member C31 is formed on one side of the outer surface thereof with a positioning surface C311 for engaging with the positioning surface C13 of the positioning groove C12 of the base C10, so that the positioning member C31 is non-rotatably received in the positioning groove C12 of the base C10. The positioning member C31 is formed on the other side of the outer surface thereof with a slope C312 that includes a deep portion C3121 and a shallow portion C3122.

The pushing member C32 is also mounted on the second outer diameter 213 of the control member 21, and both ends of the pushing member C32 are slideably disposed between the first flange 212 of the control member 21 and the connecting member 216. An interval is left between the inner diameter of the pushing member C32 and the second outer diameter 213 of the control member 21, allowing the pushing member C32 to move a predetermined distance along the second outer diameter 213 of the control member 21. The pushing member C32 is driven to move by the control member 21. A first receiving groove C321 is formed in the pushing member C32 and is located correspondingly to the slope C312 of the positioning member C31, and an abutting surface C322 is formed at the bottom of the first receiving groove C321. The pushing member C32 is formed with a second receiving grove C323 for cooperating with the slope 74 of the pushing rod 70, and an abutting surface C324 is formed at the bottom of the second receiving groove C323.

The first sliding member C33 is received in the first receiving groove C321 of the pushing member C32 in such a manner that one end of the first sliding member C33 abuts against the abutting surface C322 of the first receiving groove C321, and the other end abuts against the slope C312 of the positioning member C31.

The second sliding member C34 is received in the second receiving groove C323 of the pushing member C32 in such a manner that one end of the second sliding member C34 abuts against the abutting surface C324 of the second receiving groove C323, and the other end abuts against the slope 74 of the pushing member 70.

In the third embodiment, the slope and the receiving groove exchange positions, and the sliding member moves between the deep portion and the shallow portion, therefore, the pushing rod can move a long travel length, allowing the user to switch the buffer function quickly and laborsavingly.

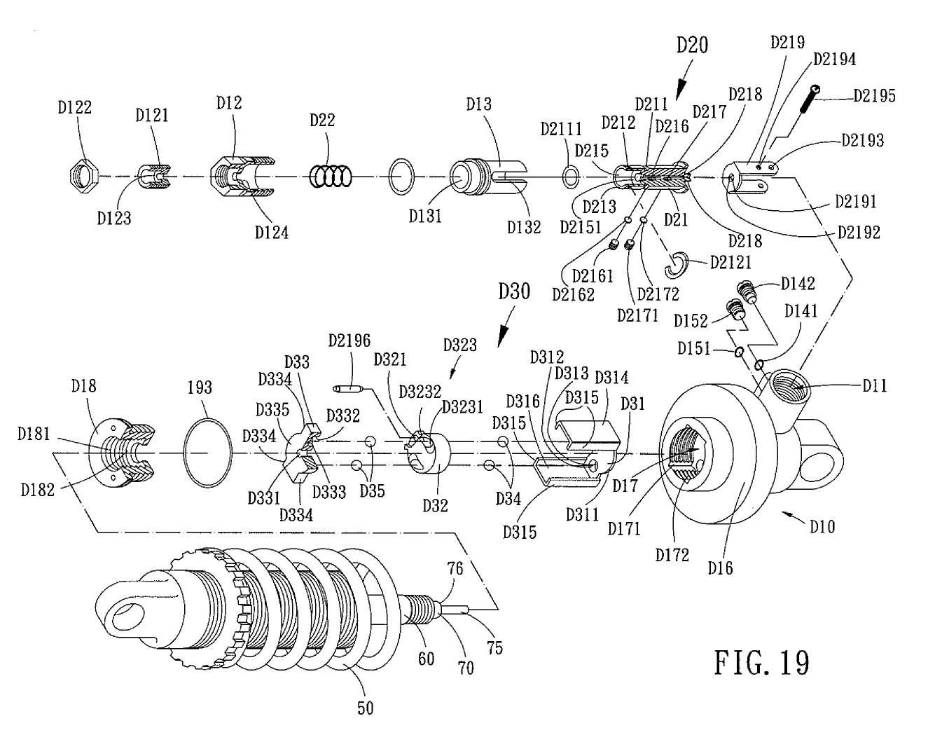

Referring to FIGS. 19-23, a fourth embodiment of the present invention also comprises: a base D10, a control assembly D20, and a moving assembly D30. The base D10 is also formed with a control hole D11 extending into the interior of the base D10. Disposed in the control hole D11 are a thread insert D12 and a bushing D13. An adjusting screw D121 and a positioning nut D122 are screwed in one end of the thread insert D12. The adjusting screw D121 is formed with a step hole D123 for insertion of steel cable 40 and a cable encasing tube 41. A positioning surface D124 is formed in the thread insert D12, the bushing D13 is fixed in the control hole D11 by the thread insert D12. The bushing D13 is formed with a through hole D131 and a positioning slot 132. A threaded positioning hole D14 is formed in the base D10 and is located correspondingly to the positioning slot D132 of the bushing D13. A positioning screw D142 is hermetically screwed in the threaded positioning hole D14 by a sealing ring D141 in such a manner that one end of the positioning screw D142 is inserted in the positioning slot D132 of the bushing D13, so that the bushing D13 is fixed in the control hole D11 of the base D10. The base D10 is formed with a threaded hole D15 which is located beside the threaded positioning hole D14, and a sealing screw D152 is hermetically screwed in the threaded hole D15 by a sealing ring D151.

The base D10 is formed on the other side with an abutting surface D16 to be pressed against the shock-absorbing spring 50. A working space D17 is formed in the base D10 which is in communication with the control hole D11. A positioning concave D171 is formed in the working space D17. A plurality of inner threads D172 for meshing with an annular thread insert D18 is formed in the working space D17 and is located close to the outer end thereof. The annular thread insert D18 is formed with a threaded hole D181 and a positioning surface D182 for connecting with the shaft 60 of he shock absorber. One end of the pushing rod 70 inside the shaft 60 extends into the interior of the working space D17 of the base D10, a step protrusion 75 is formed at the end of the pushing rod 70, and formed beside the step protrusion 75 is an annular abutting flange 76.

The control assembly D20 includes a control member D21 and a returning spring D22. The control member D21 is formed in the outer surface thereof with an annular groove D211 for reception of a sealing ring D2111. The control member D21 is hermetically and slideably received in the through hole D131 of the bushing D13 in the control hole D11 of the control member D10 in such a manner that one end of the control member D21 protrudes out of the end surface of the bushing D13. An engaging groove D212 for reception of a fastener D2121 is formed in the outer surface of the protruded end of the control member D213. The end surface of the protruded end of the control member D21 is a positioning surface D213 for allowing the control member D21 to be positioned on the positioning surface D124 of the thread insert D12 when the through hole D131 of the bushing D13 moves outward to a predetermined position. The control member D21 is positioned on the end surface of the bushing D13 by the fastener D2121 after the through hole D131 of the bushing D13 moves inward to a predetermined position. The control member D21 is formed with a receiving hole D214 and an expanding hole D215 located outside the receiving hole D214. An abutting surface D2151 is formed at the bottom of the expanding hole D215. A first threaded hole D14 and a second threaded hole D15 are formed in the outer surface of the control member D21 and are located correspondingly to the threaded positioning hole D14 and the threaded hole D15 of the base D10. A positioning screw D2161 and a washer D2162 are screwed in the first threaded hole D216, and a positioning screw D2171 and a washer D2172 are screwed in the second threaded hole D217. The steel cable 40 is inserted in the receiving hole D214 and is fixed by the positioning screws D2161, D2171 and the washers D2162, D2172. The positioning screw D2171 is screwed in the positioning screw D2171 of the control member D21 in such a manner that one end of the positioning screw D2171 protrudes into the positioning slot D132 of the bushing D13 for enabling the control member D21 to be moveably but not rotatably disposed in the through hole D131 of the bushing D13. A connecting protrusion D218 is formed on the control member D21 and is located beside the second threaded hole D217. The connecting protrusion D218 is connected to a connecting member D219. An engaging surface D2181 is formed on the connecting protrusion D218. An engaging surface D2192 is formed in the inner hole D2191 of the connecting member D219 for limiting the direction in which the control member D21 is connected to the connecting member D2194. The connecting member D2194 is formed with a connecting hole D2194 and a threaded hole D2194. A screw D2195 is screwed in the threaded hole D2194 to expand the connecting member D219, allowing a connecting shaft D2196 to be accommodated in or to be taken out of the connecting hole D2193. The elasticity of the connecting member D219 enables the connecting shaft D2196 to be received in the connecting hole D2193 more firmly. The connecting member D219 extends out from the control hole D11 into the working space D17 of the base D10. The returning spring D22 is received in the expanding hole D215 of the control member D21 and is biased between the abutting surface D215 of the expanding hole D215 and the positioning surface D124 of the thread insert D12.

The moving assembly D30 is installed in the working space D17 of the base D10 and is controlled by the control member D21. The moving assembly D30 includes a positioning member D31, a pushing member D32, a mounting member D33, a first sliding member D34 and a second sliding member D35. The slope of the moving assembly D30 is formed on the side of the pushing member D32. The positioning member D31 is received in the working space D17 of the base D10 in such a manner that a bottom D311 of the positioning member D31 abuts against the bottom of the working space D17. A receiving groove D312 is formed on the opposite surface of the bottom of the positioning member D31, and an abutting surface D313 is formed on the bottom of the receiving groove D312. A groove portion D314 is formed on the outer side the receiving groove D312 and extends outward. An engaging portion D315 is formed on the outside of the groove portion D314 and is positioned in the positioning concave D171 of the working space D17 of the base D10. A groove D316 is defined in the groove portion D314. The pushing member D32 is received in the working space D17 of the base D10 and is located beside the positioning member D31. A connecting hole D321 is formed in the pushing member D32 for engaging with the connecting shaft D2196 of the connecting member D219 of the control member. The pushing member D32 is driven to rotate by the control member D2. The pushing member D32 is formed with a first slope D322 that is located correspondingly to the receiving groove D312 of the positioning member D31. The first slope D322 includes a deep portion D3221 and a shallow portion D3222. A second slope D323 is formed on the pushing member D32 and is located opposite the first slope D322. The second slope D323 includes a deep portion D3231 and a shallow portion D3232. The mounting member D33 is received in the working space D17 of the base D10 and is located beside the pushing member D32. The mounting member D33 is formed with a through positioning hole D331 to be engaged with the step protrusion 75 of the pushing rod 70. The mounting member D33 is further formed with a receiving groove D332 that is arranged beside the through positioning hole D331 and is located correspondingly to the second slope D232 of the pushing member D32. The receiving groove D332 is formed on the bottom thereof with an abutting surface D333. An engaging portion D334 is formed on the outer surface of the mounting member D33 and is to be slideably received in the groove D316 of the groove portion D314 of the positioning member D31, so that the positioning member D33 is slideably but not rotatably received in the groove D316. A side surface D335 of the mounting member D33 abuts against the annular abutting flange 76 of the step protrusion 75 of the pushing rod 70. The first sliding member D34 is received in the receiving groove D312 of the positioning member D31 in such a manner that one end of the first sliding member D34 abuts against the abutting surface D313 of the receiving groove D312, and the other end abuts against the first slope D322 of the pushing member D32. The second sliding member D35 is received in the receiving groove D332 of the mounting member D33 in such a manner that one end of the second sliding member D35 abuts against the abutting surface D333 of the receiving groove D332, and the other end abuts against the second slope D323 of the pushing member D32.

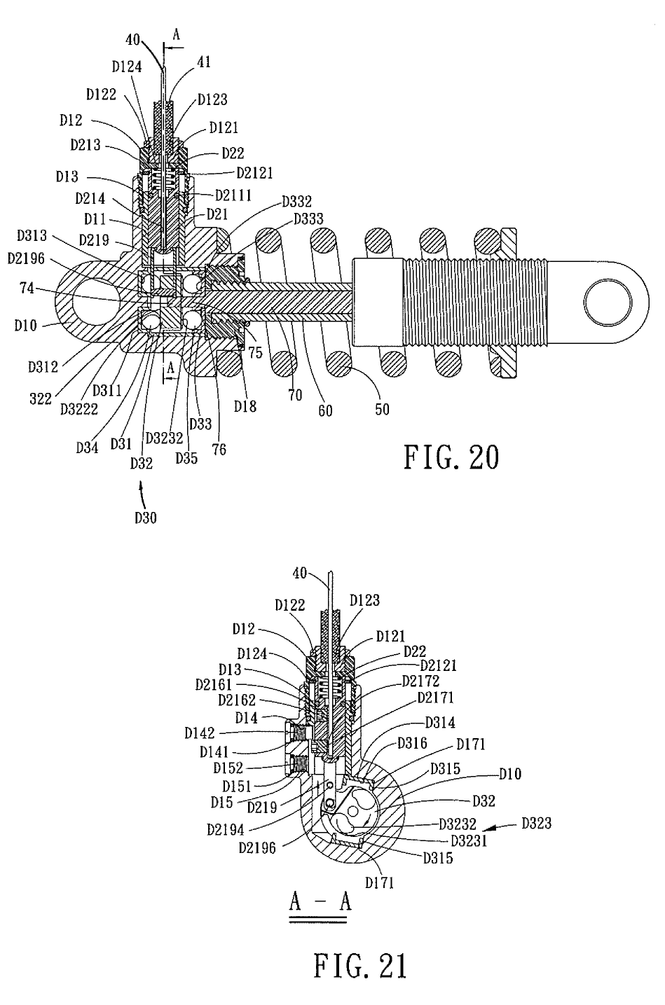

For a better understanding of the fourth embodiment, its operation and function, reference should be made to FIGS. 20-23.

As shown in FIGS. 20 and 21, when the user pulls the steel cable 40, the steel cable 40 will drive the control member D21 to move, and the positioning surface D213 will abut against the positioning surface D124 of the thread insert D12 after the control member D21 moves to a predetermined position. Meanwhile, the connecting shaft D2196 of the connecting member D219 will drive the pushing member D32 of the moving assembly D30 to rotate, the returning spring D22 will be compressed, and the first sliding member D34 will move from the deep portion D3221 to the shallow portion D3222 of the first slop D322 of he pushing member D32. At this moment, since the first sliding member D34 is received in the receiving groove D312 of the positioning member D31, plus the engaging portion D315 of he groove portion of the positioning member D31 is confined in the positioning concave D171 of the working space D17 of the mounting member D10, the first sliding member D34 will not rotate along with the pushing member D32. And another end of the first sliding member D34 abuts against the abutting surface D313 at the bottom of the receiving groove D312 of the positioning member D31, thereby, the first sliding member D34 will drive the pushing member D32 to move.

Meanwhile, the second sliding member D35 moves from the deep portion D3231 to the shallow portion D3232 of the second slope of the pushing member D32, since the second sliding member D35 is received in the receiving groove D332 of the mounting member D33, plus the engaging portion D334 of the mounting member D33 is slideably received in the groove D316 of the groove portion D314 of the positioning member D31, the second sliding member D35 will not rotate along with the pushing member D32. Further, another end of the sliding member D35 abuts against the abutting surface D333 of the receiving groove D332 of the mounting member D33, therefore, the first sliding member D34 will push the pushing member D32, the second sliding member D35 and the mounting member D33 toward the pushing rod 70 when the pushing member D32 is rotating. Meanwhile, the second slope D323 of the pushing member D32 will push the second sliding member D35 to move the mounting member D33, and another end of the mounting member D33 will abut against the annular abutting flange 76 of the pushing rod 70, 4, thus allowing the pushing rod 70 to move a long length (long travel) into the interior of the shock absorber to switch the buffer function.

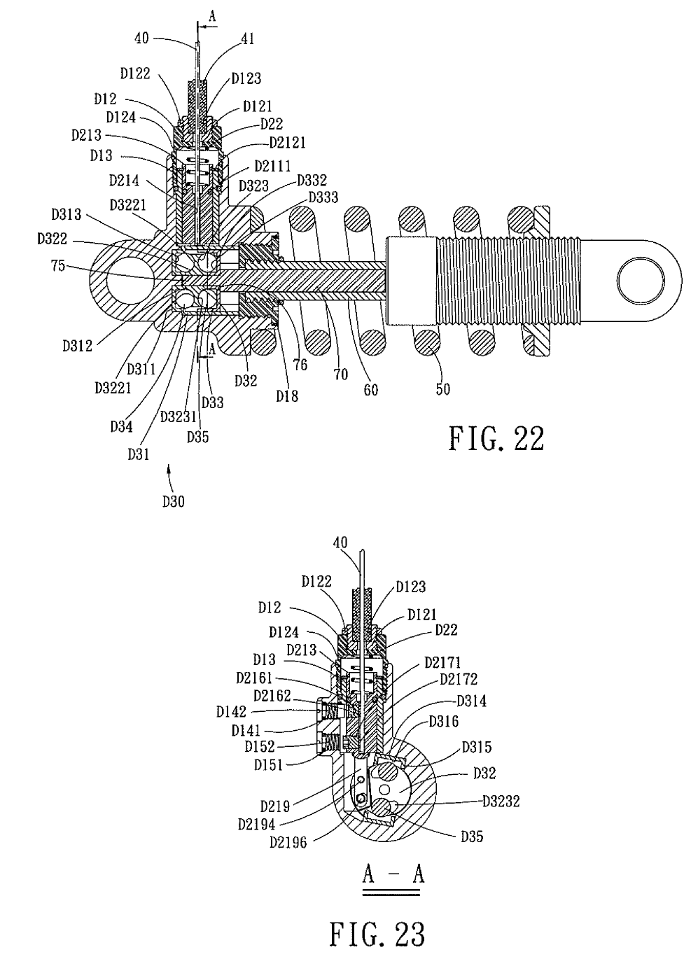

As shown in FIGS. 22 and 23, when the user releases the steel cable 40, the returning spring D22 of the control assembly D20 will push the control member D21 back to its original position. The fastener D2121 of the control member D21 will abut against the end surface of the bushing D13, meanwhile, the connecting shaft D2196 of the connecting member D219 of the control member D21 will rotate the pushing member D32 of the moving assembly D30 to its original position. At this moment, the first sliding member D34 in the receiving groove D312 of the positioning member D31 will slide from the shallow portion D3222 to the deep portion D3221 of the first slope D322 of the pushing member D32, while the second sliding member D35 in the receiving groove D332 of the mounting member D33 will also move from the shallow portion D3232 to the deep portion D3231 of the second slope D323 of the pushing member. As a result, an interval will appear between the pushing member D32, the mounting member D33 and the positioning member D31, the elastic force of the interior of the pushing rod 70 will push the mounting member D33 and the pushing member D32 to the positioning member D31. At this moment, the pushing rod 70 will protrude out and change the buffer function of the shock absorber. Therefore, the pushing rod can move a long travel length, allowing the user to switch the buffer function quickly and laborsavingly.

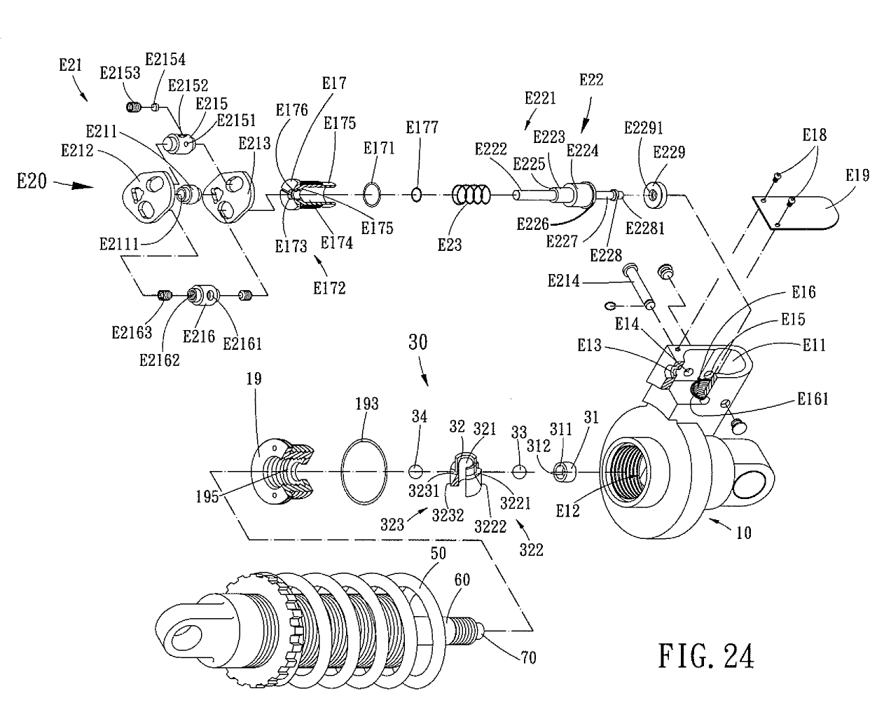

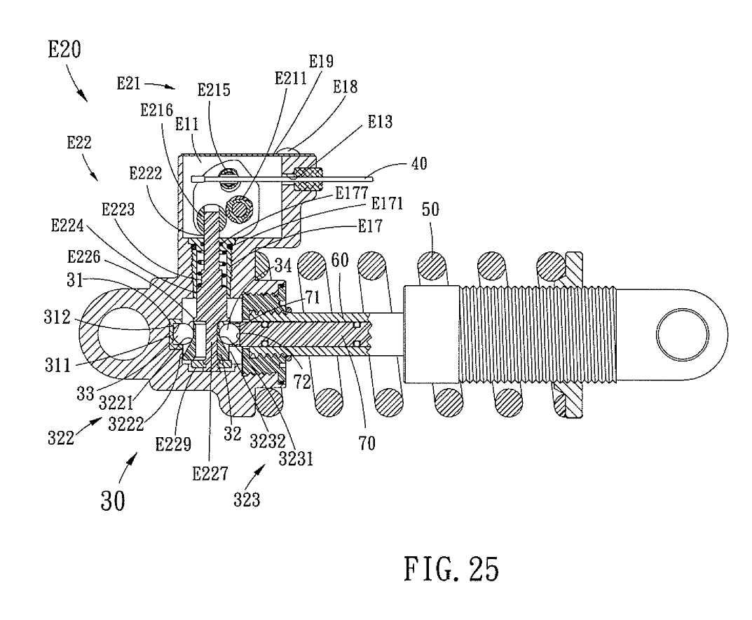

Referring to FIGS. 24-25, a fifth embodiment of the present invention is similar with the first embodiment, except that: the control assembly E20 is additionally provided with a drive member E21, the base E10 and the control member E22 are structured to cooperate with the drive member E21, and the rest components are identical to the first embodiment, so further explanation is omitted.

The base E10 is formed with a receiving space E11 and a working space E12. The receiving space E11 is provided for accommodation of the control assembly E20, and the moving assembly 30 is disposed in the working space E12. A steel cable hole E13 is formed outside the receiving space E11 for insertion of the steel cable 40 and the cable encasing tube 41. A positioning hole E14, a through hole E15, and a control hole E16 are formed in the receiving space E11. The control hole E16 extends from the bottom of the receiving space E11 to the working space E12. A plurality of inner threads E161 is formed in the control hole E16 and is located close to the outer end thereof. A frictional thread insert E17 cooperating with a sealing ring E171 is hermetically screwed in the control hole E16. The frictional thread insert E17 is formed with a step hole E172 having a small inner hole E173 and a large inner hole E174. The annular connecting portion between the small inner hole E173 and the large inner hole E174 serves as a positioning surface E175. An annular groove E176 is formed in the smaller inner hole E173 for reception of a sealing ring E177. A cap E19 is fixed to the gate of the receiving space E11 of the base E10 by a screw E18.

The control assembly E20 includes a drive member E21, a control member E22, and a returning spring E23.

The drive member E21 includes a bushing E211 and a pair of sheet members E212, E213. The bushing member E211 of the drive member E21 is formed with a positioning hole E2111 for insertion of a positioning shaft E214. The positioning shaft E214 is inserted through the positioning hole E14 of the base E10 and the positioning hole E2111 of the drive member E21, and serves to fix the drive member E21 in the receiving space E11 of the base E10.

The drive member E21 is provided with a first drive shaft E215 which is located approximately perpendicular to the positioning hole E2111. A through hole E2151 is formed in the drive member E21 and located along the axial direction thereof. A threaded hole E2152 is formed perpendicular to the through hole E2151, for reception of a positioning screw E2153 and a washer E2154. The steel cable 40 controlled by the user is inserted through the steel cable hole E13 of the base E10, and is fixed in the through hole E2151 of the first drive shaft E215 by the positioning screw E2153 and the washer E2154.

The drive member E21 is provided with a second drive shaft E216 which is approximately located parallel to the positioning hole E2111. The second drive shaft E216 is axially formed with a through hole E2161, and two threaded holes E2162 at both sides of the through hole E2161 for reception of two positioning screws E2163. The control member E22 is received in the control hole E16 of the base E10. A stepped outer diameter E221 is formed at one end of the control member E22 and includes a first outer diameter E222, a second outer diameter E223, and a third outer diameter E224. The first outer diameter E222 and the third outer diameter E224 are frictionally and slideably received in the step hole E172 of the frictional thread insert E17. The first outer diameter E222 is hermetically and slideably sealed in the smaller inner hole E173 of the frictional thread insert E17 by a sealing ring E177 and extends out of the frictional thread insert E17 and is finally fixed in the through bole E2161 of the second drive shaft E216 of the drive member E21 by two positioning screws E2163.

The connecting portion between the first outer diameter E222 and the second outer diameter E223 of the control member E22 is a positioning surface E225. The positioning surface E225 of the control member E22 is to be positioned on the positioning surface E175 of the frictional thread insert E17 after the step hole E172 of the frictional thread insert E17 slides to the final position.

A flange E226 is formed at another end of the control member E22 and is located next to the third outer diameter E224. A third outer diameter E227 is located beside the flange E226, a second flange E228 is formed beside the third outer diameter E227, and located next to the second flange E228 is a riveting portion E2281. A connecting member E229 is formed with a step hole E2291 through which the connecting member E2229 is mounted on the second flange E228 of the control member E22 and the riveting portion E2281 and is to be connected to the control member E22 by riveting. The control member E22, the first flange E226, the second outer diameter E227, and the connecting member E229 extend into the working space E12 of the base E10. The inner diameter 321 of the pushing member 32 of the moving assembly 30 is mounted on the fourth outer diameter E227 of the control member E22, and both ends of the pushing member 32 are slideably disposed between the first flange E226 of the control member E22 and the connecting member E229. An interval is left between the inner diameter 321 of the pushing member 32 and the fourth outer diameter E227 of the control member E22, for allowing the pushing member 32 to move a predetermined distance along the fourth outer diameter E227. The control member E22 drives the pushing member 32 to move. The returning spring E23 is mounted on the second outer diameter E223 of the control member E22 and is biased between the positioning surface E175 of the frictional thread insert E17 and the annular connecting portion between the second outer diameter E223 and the third outer diameter E224 of the control member E22.

When the user pulls the steel cable 40, the drive member E21, the control member E22 and the pushing member 32 of the moving assembly 30 will be driven to move successively, so as to change the buffer function of the shock absorber. Since the frames of the vehicle (bicycle) have various shapes, the drive member E21 in this fifth embodiment is shaped to match the frame of the bicycles, the extending direction of the steel cable 40 change, and the operation of this embodiment is the same as that of the first embodiment, further explanations are omitted.

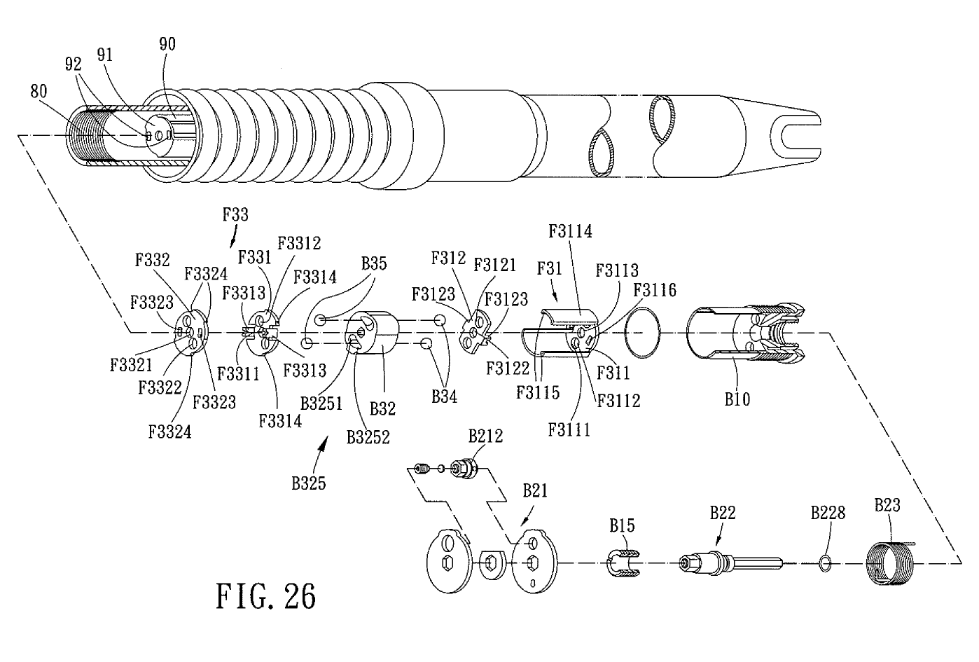

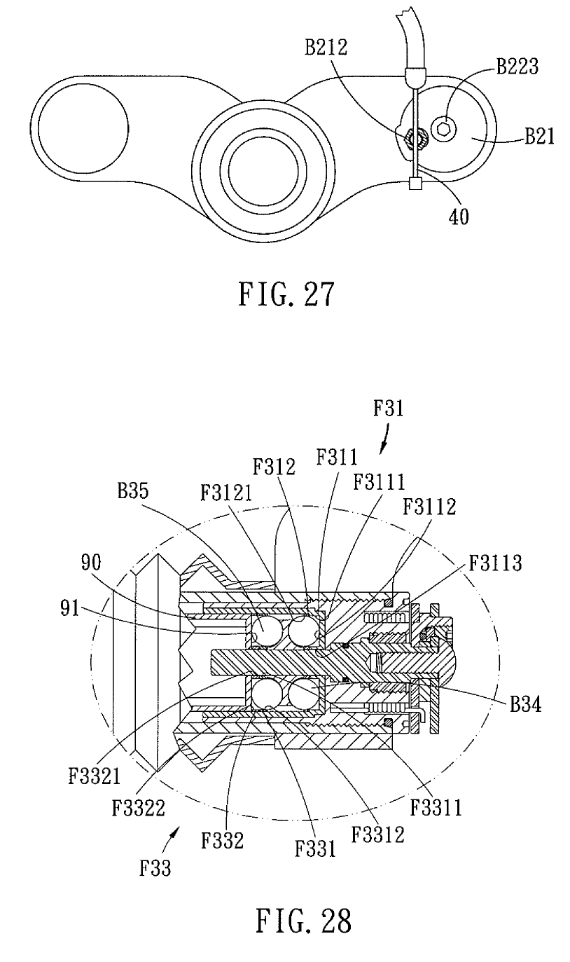

Referring to FIGS. 26-28, a sixth embodiment of the present invention is similar with the second embodiment, except that: the positioning member B31 of the moving assembly B30 is changed to be a two-piece assembly, the mounting member B33 is also changed to be a two-piece assembly, and the abutting surface B333 at the bottom of the receiving groove B332 of the mounting member B33 is also changed to the end surface 91 of the pushing rod 90. A positioning hole 92 is formed in the end surface 91, and the rest components are identical to the first embodiment, so further explanation is omitted. The positioning assembly F31 includes a first positioning member F311 and a second positioning member F312. The first positioning member F311 is formed with a receiving groove F3111, an abutting surface F3112, a through hole F3113, and a groove portion F3114. A groove F3115 is formed in the groove portion F3114. As compared with the second embodiment, the first positioning member F311 is formed with positioning hole F3116, and the receiving groove F3111 is reduced in depth. The second positioning member F312 is formed with receiving hole F3121, a through hole F3122 and a positioning protrusion F3123 formed beside the through hole F3122. The second positioning member F312 is fixed to the first positioning member by inserting the positioning protrusion F3123 into the positioning hole F3116.

The positioning assembly F31 is assembled by the use of the through hole F3121 and the receiving groove F3111, and the receiving groove F3111 is shallow than the receiving groove B312 of the second embodiment, therefore, making it easier to produce.

The mounting assembly F33 includes a first mounting member F331 and a second mounting member F332. The first mounting member F331 is formed with a through positioning hole F3311, and located beside the through positioning hole P3311 are a receiving hole F3312 and a positioning protrusion F3313. An engaging portion F3314 is formed on the outer periphery of the first mounting member P331 and is to be slideably received in the groove F3115 of the positioning member F31. The second mounting member F332 is formed with a through positioning hole F3321, and located beside the through positioning hole F3321 are a receiving hole F3322 and a positioning hole F3323. An engaging portion F3324 is formed on the outer periphery of the second mounting member F332 and is to be slideably received in the groove F3115 of the positioning member F31. The positioning protrusion F3313 of the first mounting member F331 is inserted through the positioning hole F3323 of the second mounting member F332 and is fixed in the positioning hole 92 of the pushing rod 90, so that the first mounting member F331, the second mounting member F332 and the pushing rod 90 are connected to one another.

The first sliding member B34 is received in the receiving groove F3111 of the first positioning member F311 and the receiving hole F3121 of the second positioning member F312. The second sliding member B35 is slideably received in the receiving holes F3312, F3322 of the first mounting member F331 and the second mounting member F332, in such a manner that one end of the second sliding member B35 abuts against the second slope B325 of the pushing member B32 and another end abuts against the end surface 91 of the pushing rod 90.

The mounting assembly F33 is designed to be a two-piece assembly fixed to the pushing rod 90 of the shock absorber, so it can be produced more easily and quickly by pressing or punching process.

The operation and function of the sixth embodiment is the same as the second embodiment.

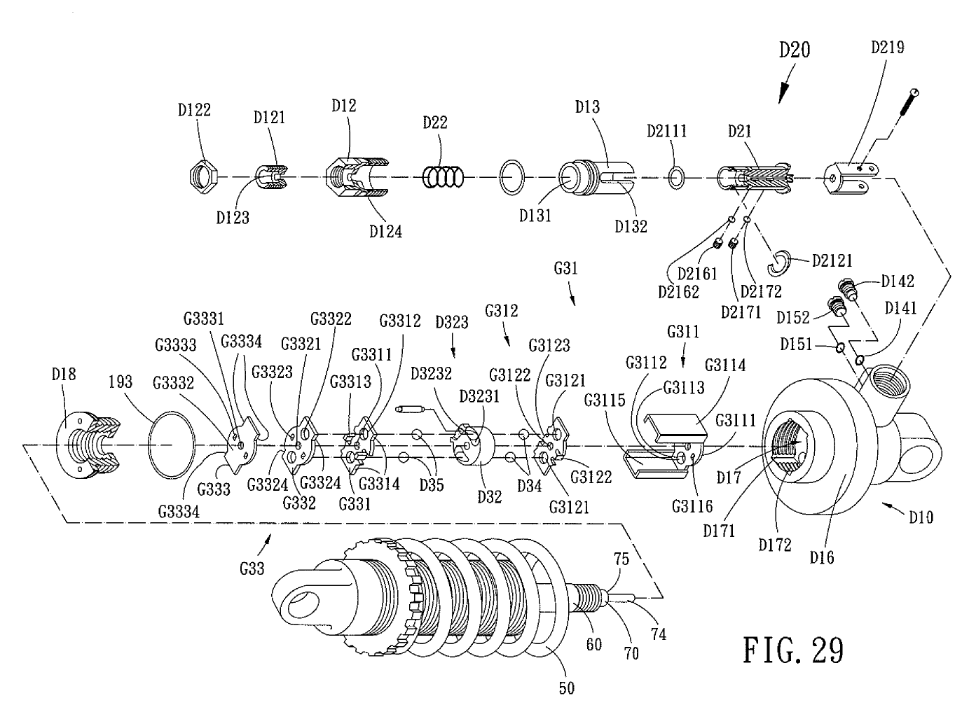

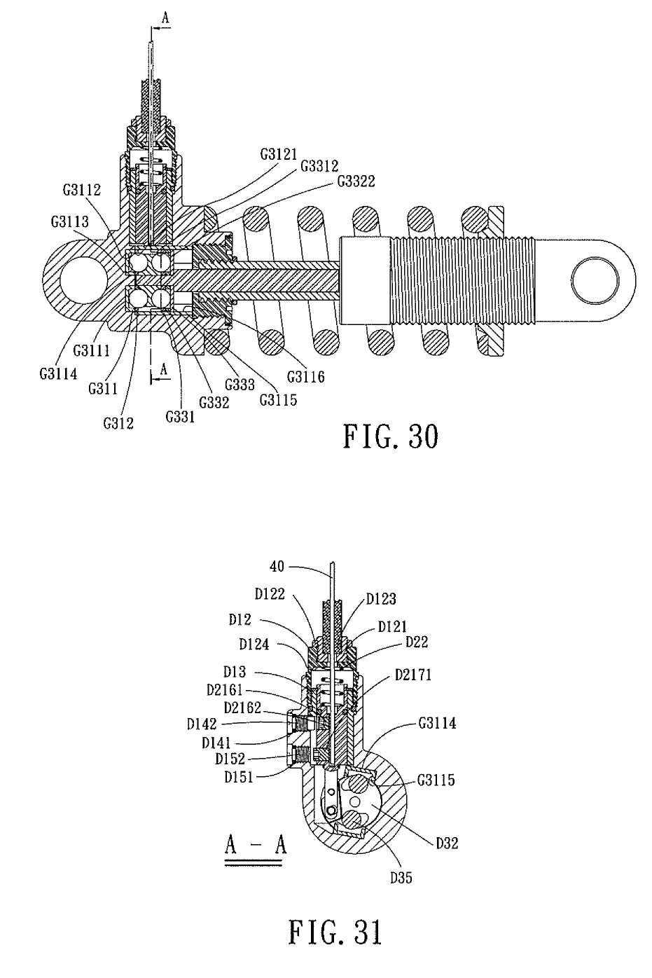

Referring to FIGS. 29-31, a seventh embodiment of the present invention is similar with the fourth embodiment, the positioning member D31 and the mounting member D33 of the moving assembly D30 of the fourth embodiment have been changed to be a two-piece assembly, and the rest components of the seventh embodiment are the same as those of the fourth embodiment, so further explanations are omitted. The positioning assembly G31 includes a first positioning member G311 and the second positioning member G312. The first positioning member G311 is disposed in the working space D17 of the base D10 in such a manner that the bottom of the first positioning member G311 abuts against the bottom of the working space D17 and is defined with a receiving groove G3112. An abutting surface G3113 is formed at the bottom of the receiving groove G3112. A groove portion G3114 is formed at the outer side of the receiving groove G3112, and a groove G3115 is formed in the groove portion G3114. The difference is that the first positioning member G311 is formed with positioning hole G3116, and the receiving groove G3111 is reduced in depth. The second positioning member G312 is formed with receiving hole G3121 and a positioning protrusion G3122 formed beside the through hole G3121. The second positioning member G312 is fixed to the first positioning member by inserting the positioning protrusion G3122 into the positioning hole G3116.

The positioning assembly G31 is assembled by the use of the receiving hole G3121 and the receiving groove G3111, and the receiving groove G3111 is shallow than the receiving groove D312 of the fourth embodiment, therefore, making it easier to produce.

The mounting assembly G33 includes a first mounting member G331, a second mounting member G332 and a third mounting member G333. The first mounting member G331 is located beside the pushing member D32 of the moving assembly D30 and is formed with a through positioning hole G3311. A receiving hole G3312 is formed beside the through positioning hole G3311 and is located correspondingly to the second slope D323 of the pushing member D32, and a positioning protrusion G3313 is formed beside the through positioning hole G3311. The first mounting member G331 is formed on its outer surface with an engaging portion G3314 to be slideably received in the groove G3315 of the positioning member G31.

The second mounting member G332 is located beside the first mounting member G331 and is formed with a through positioning hole G3321. A receiving hole G3322 is formed beside the through positioning hole G3321 and is located correspondingly to the receiving hole g3312 of the first mounting member G331. A positioning hole G3323 is formed in the second mounting member G332. The second mounting member G332 is formed on the outer surface thereof with an engaging portion G3324 that is to be slideably disposed in the groove G3115 of the positioning member G31.

The third mounting member G333 is disposed beside the second mounting member G332 and is formed with a positioning hole G3331, an abutting surface G3332 and a positioning hole G3333. An engaging portion G3334 is formed on the outer surface of the third mounting member G333 and is to be slideably received in the groove G311 of the positioning member G31. The receiving hole G3312 of the first mounting member G331, the receiving hole G3322 of the second mounting member G332, and the abutting surface G3332 of the third mounting member G333 cooperate with each other to form a receiving groove for reception of the second sliding member D35.

The positioning protrusion G3313 of the first mounting member G331 is inserted in the positioning hole G3323 of the second mounting member G332, and the positioning hole G3333 of the third mounting member G333, so that the first mounting member G331, the second mounting member G332 and the third mounting member G333 are connected.

The receiving groove of the mounting assembly G33 is designed to be a three-piece combination, so it can be produced more easily and quickly by pressing or punching process.

The operation and function of the seventh embodiment is the same as the fourth embodiment.

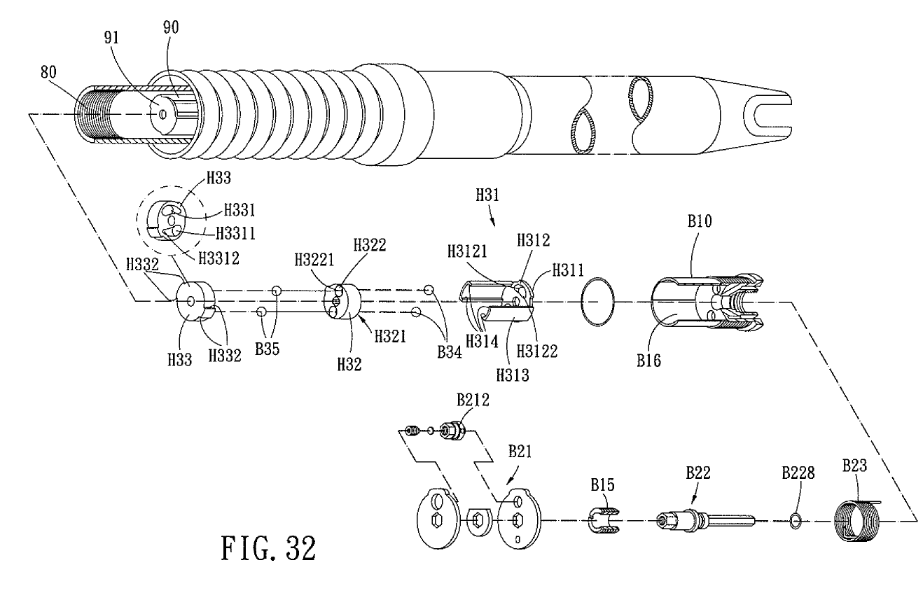

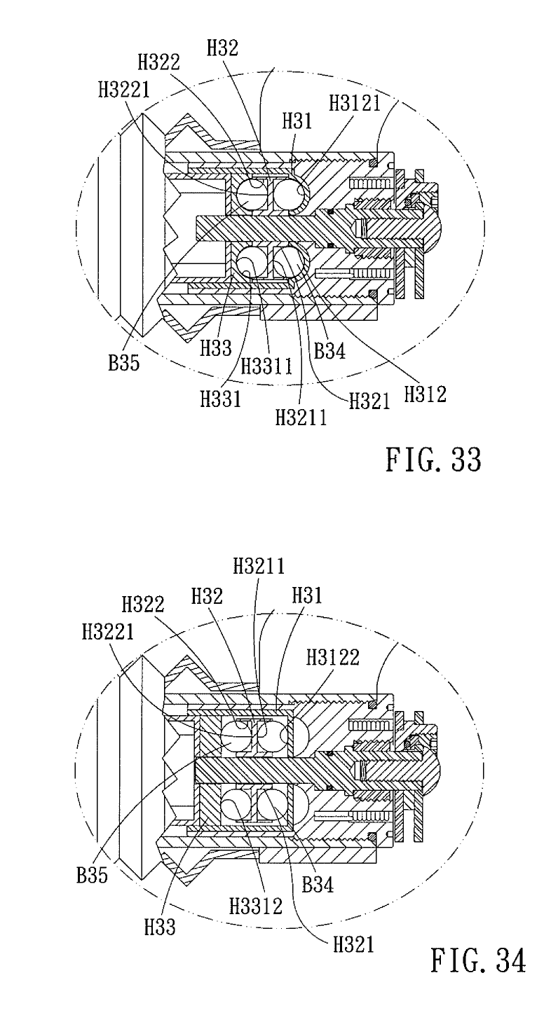

Referring to FIGS. 32-34, a eighth embodiment of the present invention is similar with the second embodiment, the receiving groove B312 in the positioning member B31 of the moving assembly B30 and the first slope B324 of the pushing member B32 have exchanged positions, and the second slope B325 of the pushing member B32 and the receiving groove B332 of the mounting member B33 have also exchanged positions. The moving assembly is formed with a slope for cooperating with the sliding member, and is further provided with a positioning member for cooperating with the sliding member, and the pushing member or the pushing rod is formed with a slope. The rest components are identical to the second embodiment, so further explanation is omitted.

The positioning member H31 is disposed in the working space B16 of the base B10 in such a manner that the bottom of the positioning member H31 abuts against the bottom of the working space B16. A slope H312 is formed on the back surface of the bottom H311 of the positioning member H31 and includes a deep portion H3121 and a shallow portion H3122. The positioning member H31 is formed on its outer surface with a groove portion H313, and a groove H314 is formed in the groove portion H313.

The pushing member H32 is received in the working space B16 of the base B10 and is located beside the positioning member H31. The pushing member H32 is formed in its surface facing the positioning member H31 with a first receiving groove H321 which is located correspondingly to the slope H312 of the positioning member H31. An abutting surface H3211 is formed at the bottom of the first receiving groove H321, a second receiving groove H322 is formed the surface of the pushing member H32 opposite the first receiving groove H321, and an abutting surface H3221 is formed at the bottom of the second receiving groove H322.

The mounting member H33 is received in the working space B16 of the base B10 and is located beside the pushing member H32. A slope H331 is formed on the mounting member H33 and is located correspondingly to the second receiving groove H322 of the pushing member H32. The slope H331 includes a deep portion H3311 and a shallow portion H3312. The mounting portion H33 is formed on its outer surface with an engaging portion H332 to be slideably received in the groove H314 of the positioning member H31.

The first sliding member B34 is slideably received in the first receiving groove H321 of the pushing member H32 in such a manner that an end of the first sliding member B34 abuts against the abutting surface H3211 at the bottom of the first receiving groove H321, and another end abuts against the slope H312 of the positioning member H31.

The second sliding member B35 is slideably disposed in the second receiving groove H322 in such a manner that an end of the second sliding member B35 abuts against the abutting surface H3221 of the second receiving groove H322, and another end abuts against the slope H331 of the mounting member H33.

The slope and the receiving groove in this eighth embodiment have exchanged positions, and similarly, a long travel can be obtained with laborsaving operations, namely, the rolling friction of the sliding member allows the user to switch the buffer function of the shock absorber and laborsavingly.

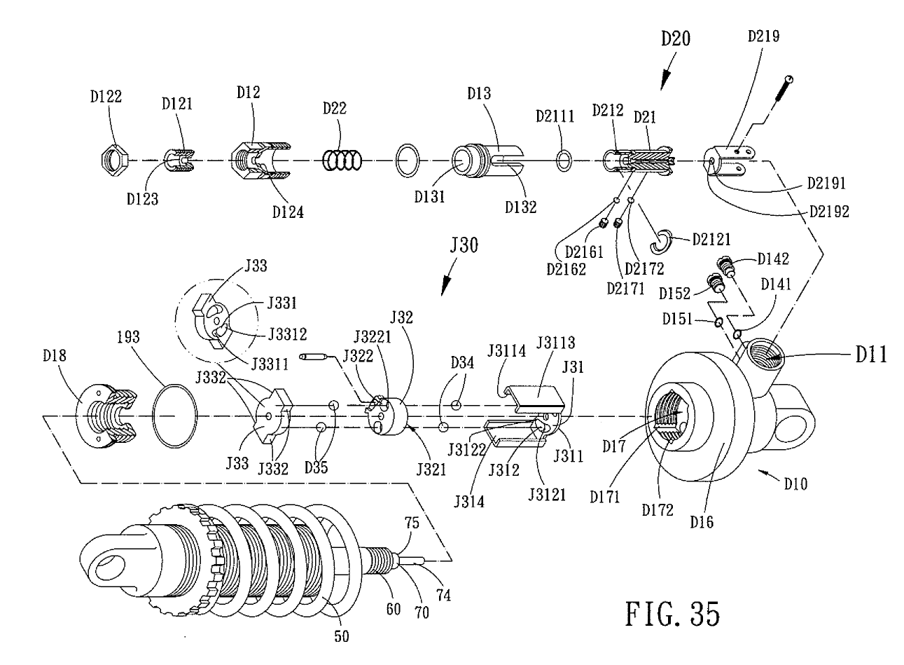

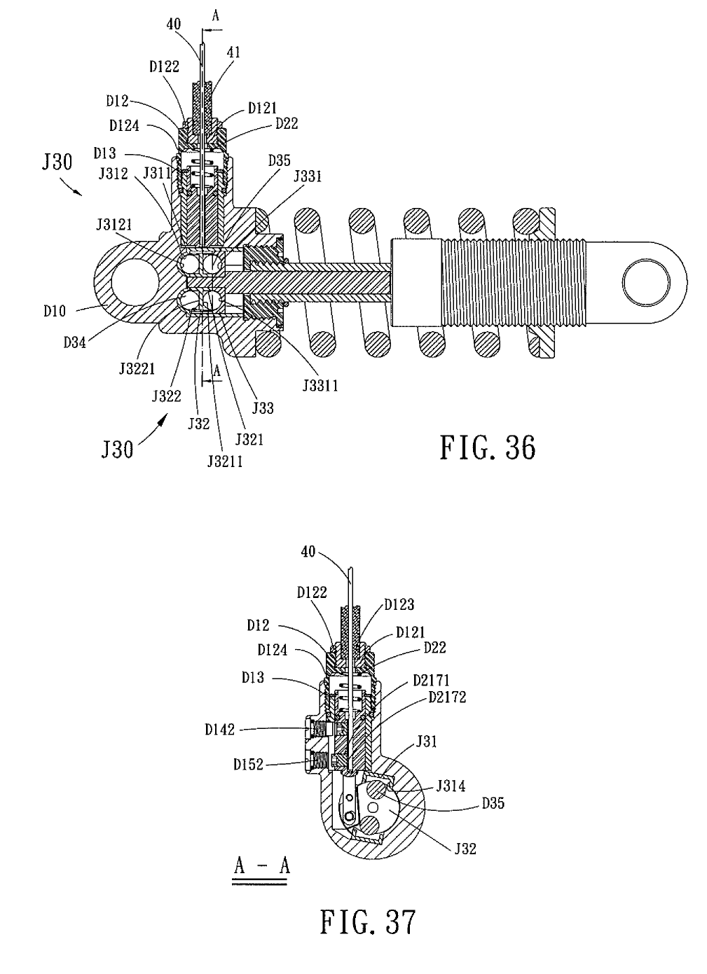

Referring to FIGS. 35-37, a ninth embodiment of the present invention is similar with the fourth embodiment, the receiving groove D312 in the positioning member D31 of the moving assembly D30 and the first slope D322 of the pushing member D32 have exchanged positions, and the second slope D323 of the pushing member D32 and the receiving groove D332 of the mounting member D33 have also exchanged positions. The moving assembly is formed with a slope for cooperating with the sliding member, and is further provided with a positioning member for cooperating with the sliding member, and the pushing member or the pushing rod is formed with a slope. The rest components are identical to the second embodiment, so further explanation is omitted.

The positioning member J31 is disposed in the working space D17 of the base D10 in such a manner that the bottom of the positioning member J31 abuts against the bottom of the working space D17. A slope J312 is formed on the back surface of the bottom J311 of the positioning member J31 and includes a deep portion J3121 and a shallow portion J3122. The positioning member J31 is formed on its outer surface with a groove portion J313, and a groove J314 is formed in the groove portion J313.

The pushing member J32 is received in the working space D17 of the base D10 and is located beside the positioning member J31. The pushing member J32 is formed in its surface facing the positioning member J31 with a first receiving groove J321 which is located correspondingly to the slope J312 of the positioning member J31. An abutting surface J3211 is formed at the bottom of the first receiving groove J321, a second receiving groove J322 is formed the surface of the pushing member J32 opposite the first receiving groove J321, and an abutting surface J3221 is formed at the bottom of the second receiving groove J322.

The mounting member J33 is received in the working space D17 of the base D10 and is located beside the pushing member J32. A slope J331 is formed on the mounting member J33 and is located correspondingly to the second receiving groove J322 of the pushing member J32. The slope J331 includes a deep portion J3311 and a shallow portion J3312. The mounting portion J33 is formed on its outer surface with an engaging portion J332 to be slideably received in the groove J314 of the positioning member J31.

The first sliding member D34 is slideably received in the first receiving groove J321 of the pushing member J32 in such a manner that an end of the first sliding member J34 abuts against the abutting surface J3211 at the bottom of the first receiving groove J321, and another end abuts against the slope J312 of the positioning member J31.

The second sliding member D35 is slidably disposed in the second receiving groove J322 in such a manner that an end of the second sliding member D35 abuts against the abutting surface J3221 of the second receiving groove J322, and another end abuts against the slope J331 of the mounting member J33.

The slope and the receiving groove in this ninth embodiment have exchanged positions, and similarly, a long travel can be obtained with laborsaving operations, namely, the rolling friction of the sliding member allows the user to switch the buffer function of the shock absorber and laborsavingly.

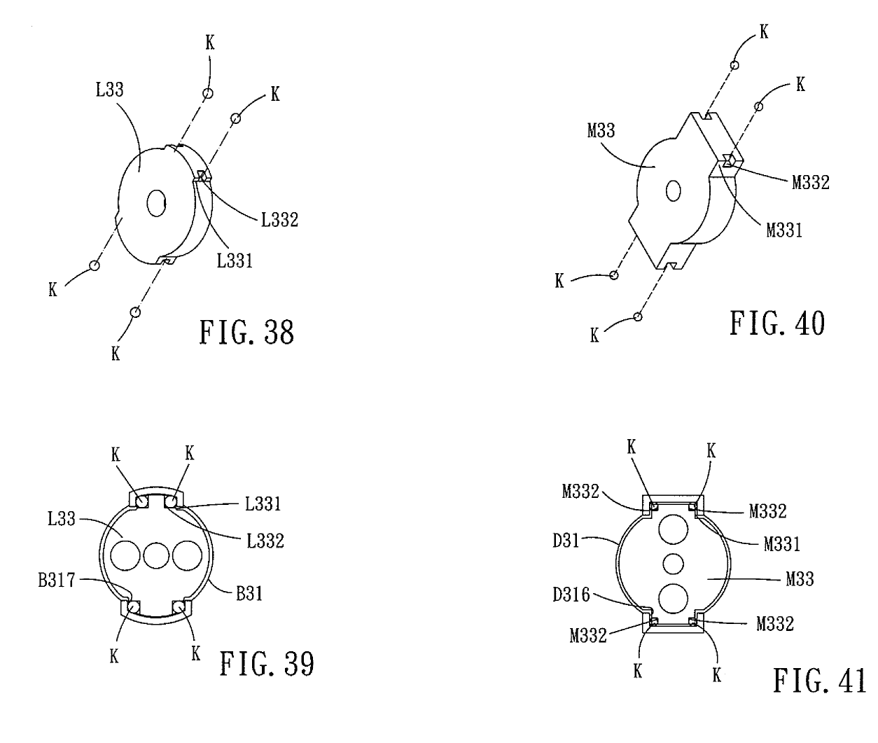

Referring to FIGS. 38-49, which show the embodiments of mounting members modified from the second, fourth, seventh, eighth and ninth embodiments, that is, a plurality of assistant sliding members K is additionally disposed between the engaging portion of the mounting member and the groove portion of the positioning member. FIGS. 38 and 39 show another embodiment of the mounting member B33 modified from the second embodiment, wherein the engaging portion L331 of the mounting member L33 is formed with a receiving groove L332 in which being received the assistant sliding members K. The assistant sliding members K are employed to roll within the groove B317 of the positioning member B31, allowing the engaging portion L331 of the mounting member L33 to slide more smoothly in the groove B317 of the positioning member B31.

FIGS. 40 and 41 show another embodiment of the mounting member D33 modified from the fourth embodiment, wherein the engaging portion M331 of the mounting member M33 is formed with a receiving groove M332 in which being received the assistant sliding members K. The assistant sliding members K are employed to roll within the groove D316 of the positioning member D31, allowing the engaging portion M331 of the mounting member M33 to slide more smoothly in the groove D317 of the positioning member D31.

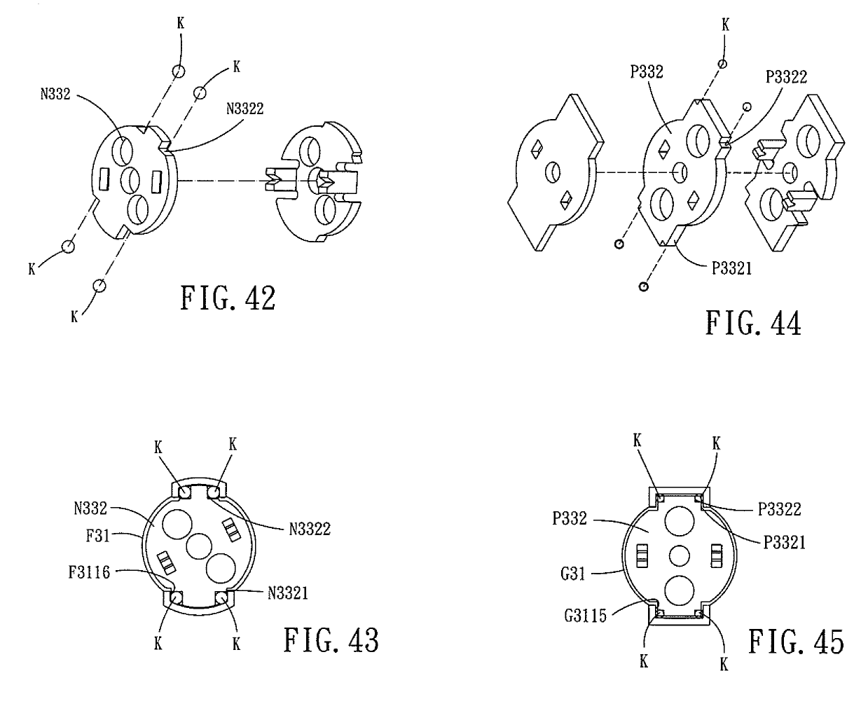

FIGS. 42 and 43 show another embodiment of the second mounting member F332 of the mounting assembly F33 modified from the sixth embodiment, wherein the engaging portion N3321 of the mounting member N332 is formed with a receiving groove N3322 in which being received the assistant sliding members K. The assistant sliding members K are employed to roll within the groove F3115 of the positioning member B31, allowing the engaging portion of the mounting member F33 to slide more smoothly in the groove F3115 of the positioning member F31.

FIGS. 44 and 45 show another embodiment of the second mounting member G332 of the mounting assembly F33 modified from the sixth embodiment, wherein the engaging portion N3321 of the mounting member N332 is formed with a receiving groove N3322 in which being received the assistant sliding members K. The assistant sliding members K are employed to roll within the groove F3115 of the positioning member B31, allowing the engaging portion of the mounting member F33 to slide more smoothly in the groove F3115 of the positioning member F31.

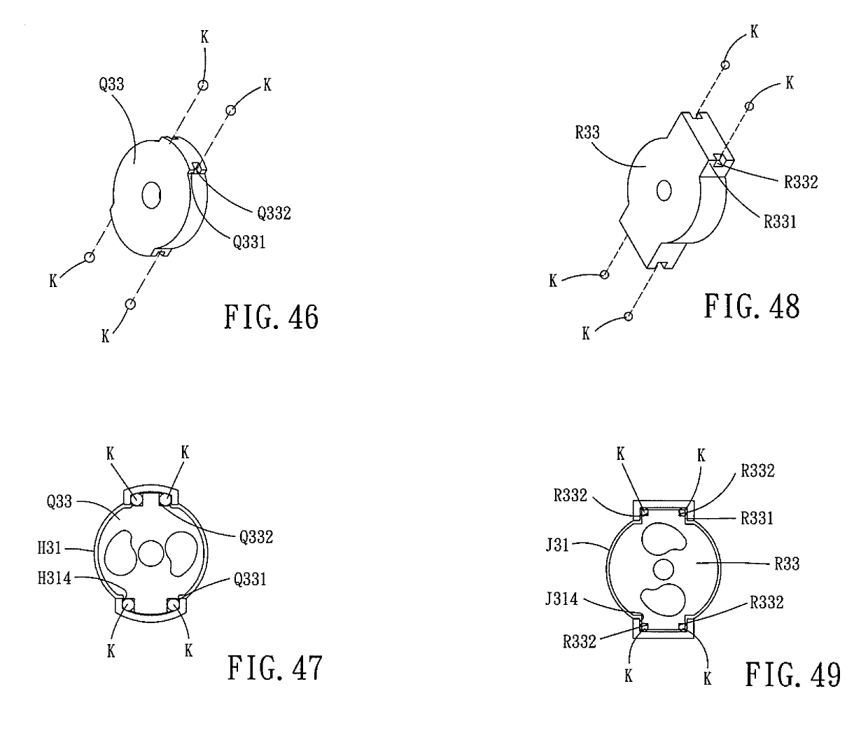

FIGS. 46 and 47 show another embodiment of the mounting member H33 modified from the eighth embodiment, wherein the engaging portion Q331 of the mounting member Q33 is formed with a receiving groove Q332 in which being received the assistant sliding members K. The assistant sliding members K are employed to roll within the groove H314 of the positioning member H31, allowing the engaging portion Q331 of the mounting member Q33 to slide more smoothly in the groove H314 of the positioning member H31.

FIGS. 48 and 49 show another embodiment of the mounting member J33 modified from the ninth embodiment, wherein the engaging portion R331 of the mounting member R33 is formed with a receiving groove R332 in which being received the assistant sliding members K. The assistant sliding members K are employed to roll within the groove J314 of the positioning member J31, allowing the engaging portion R331 of the mounting member R33 to slide more smoothly in the groove J314 of the positioning member J31.

The moving assembly is formed with a slope for cooperating with the sliding member, and is further provided with a positioning member for cooperating with the sliding member, and the number of the sliding member can be increased or decreased according to the number of the slopes.

To summarize, the shock absorber is provided with a pushing rod capable of switching the buffer function, and the control structure of the shock absorber of the present invention comprises: a base, a control assembly, and a moving assembly. The control assembly controls the motion of the moving assembly and is moved by a steel cable. A control member and a returning spring of the control assembly serve to control the motion of the moving assembly. The steel cable drives the control member to move, and the returning spring provides an elastic force for returning the relative components to their original positions. The shock absorber is defined with a working space for reception of the moving assembly. The moving assembly is provided with sliding members, and is formed with slopes form cooperating with the sliding members. When the control member drives the moving assembly to move, the pushing member of the moving assembly will push the sliding members from the deep portion to the shallow portion of the moving member, thus making the pushing rod move.

While we have shown and described various embodiments in accordance with the present invention, it is clear to those skilled in the art that further embodiments may be made without departing from the scope of the present invention.

What is claimed is:

1. A control structure for a shock absorber installed at a side of the shock absorber, the shock absorber provided with a pushing rod for switching buffer function of the shock absorber, the control structure comprising: a base, a control assembly, and a moving assembly, the control assembly serving to control the moving member;
a pushing member of the moving assembly being driven to move by the control assembly, a sliding member of the moving member being located beside the pushing member, the moving assembly being formed with a slope for cooperating with the sliding member, when the pushing member moves, the sliding member will be caused to move between a deep portion and a shallow portion of the slope to drive the pushing rod of the shock absorber to move, switching the buffer function of the shock absorber.

2. The control structure for a shock absorber as claimed in claim 1, wherein:
a receiving groove is formed in a side of the pushing rod of the shock absorber, and an abutting surface is formed at a bottom of the receiving groove;
the control assembly and the moving assembly are installed on the based, the control assembly controls the moving assembly;
the control assembly includes a control member and a returning spring, a side of the control member is connected to a steel cable, the returning spring provides an elastic force for returning relative components to their original positions;
the moving assembly includes a positioning member, a pushing member, a first sliding member, and a second member, the positioning member is formed with a receiving groove, an abutting surface is formed at the bottom of the receiving groove, the pushing member is formed with a first slope located correspondingly to the receiving groove of the positioning member, the first slope includes a deep portion and a shallow portion, a second slope is formed on the pushing member and is located correspondingly to the receiving groove of the pushing rod and includes a deep portion and a shallow portion;
the first sliding member is received in the receiving groove of the positioning member in a such manner that one end of the first sliding member abuts against the abutting surface of the receiving groove, and the other end of the first sliding member abuts against the first slope of the pushing member;
the second sliding member is received in the receiving groove of the positioning member in a such manner that one end of the second sliding member abuts against the abutting surface of the receiving groove, and the other end of the first sliding member abuts against the second slope of the pushing member, when the control assembly drives the pushing member to move, the first sliding member and the second sliding member will move between the deep portion and the shallow portion of the first slope and the second slope.

3. The control structure for a shock absorber as claimed in claim 2, wherein a control hole and a working space are formed in the base, a bushing is installed in the control hole and is formed with a through hole, the moving assembly is installed in the working space, a receiving groove is formed in the bottom of the working space;
the control member of the control assembly has a first outer diameter that is to be slideably received in the through hole of the bushing installed in the control hole of the base, a first flange is formed beside the first outer diameter, a second outer diameter is formed beside the first flange, a riveting portion is formed beside the second outer diameter, and a connecting member is riveted to the riveting portion;
the positioning member of the moving assembly is received in the receiving groove of the working space of the base;
the pushing member of the moving assembly is mounted on the second outer diameter of the control member, there is an interval between the pushing member and the second outer diameter of the control member, the pushing member is slideably disposed between the first flange and the connecting member, the pushing member is driven to move by the control member of the control assembly, the pushing member is formed with the first slope located correspondingly to the receiving groove of the positioning member, the first slope includes a deep portion and a shallow portion, the second slope is formed on the pushing member and is located correspondingly to the receiving groove of the pushing rod and includes a deep portion and a shallow portion.

4. The control structure for a shock absorber as claimed in claim 1, wherein
the moving assembly and the moving assembly are installed on the base, the control assembly controls the moving assembly, the base is formed with a working space;
the pushing rod of the shock absorber is formed on a side thereof with a slope, the slope includes a deep portion and a shallow portion, and one end of the pushing rod formed with the slope extends into the working space of the base;
the moving assembly is received in the working space of the base, the moving assembly includes a positioning member, a pushing member, a first sliding member, and a second sliding member;
the positioning member is formed with a slope that includes a deep portion and a shallow portion;
a first receiving groove is formed in the pushing member and is located correspondingly to the slope of the positioning member, an abutting surface is formed at the bottom of the first receiving groove, a second receiving groove is formed in the pushing member and is located correspondingly to the slope of the pushing rod, an abutting surface is formed at the bottom of the second receiving groove;
the first sliding member is received in the first receiving groove of the pushing member in such a manner that one end of the first sliding member abuts against the abutting surface of the receiving groove, and the other end of the first sliding member abuts against the slope of the positioning member;
the second sliding member is received in the second receiving groove of the pushing member in such a manner that one end of the second sliding member abuts against the abutting surface of the receiving groove, and the other end of the second sliding member abuts against the slope of the pushing rod, when the control assembly drives the pushing member to move, the first sliding member and the second sliding member will move between the deep portion and the shallow portion of the first slope and the second slope.

5. The control structure for a shock absorber as claimed in claim 1, wherein a control hole is formed in the base for accommodation of a thread insert and a bushing, the bushing is fixed in the control hole by the thread insert, a positioning surface is formed in the thread insert, a through hole is formed in the bushing, the control member of the control assembly is slideably received in the through hole of he bushing, and one end of the control member is confined between an end surface of the bushing and the positioning surface of the thread insert.

6. The control structure for a shock absorber as claimed in claim 1, wherein a control hole is formed in the base for reception of a bushing having a through hole, a positioning hole is formed in the outer surface of the bushing, a threaded positioning hole is formed in the base and is located correspondingly to the positioning hole of the bushing, a positioning screw is screwed in the threaded positioning hole, the bushing is fixed in the control hole of the base by the positioning screw, a positioning slot is formed in the outer periphery of the bushing, the control member of the control assembly is slideably received in the through hole of the bushing, a threaded hole is formed in the side of the control member and is located along the axial direction thereof, a positioning shaft is screwed in the threaded hole, one end of the positioning shaft is slideably received in the positioning groove of the bushing.

7. The control structure for a shock absorber as claimed in claim 1, wherein the base is formed with a working space, a threaded hole is formed in the working space and is located close to the outer end thereof, an annular thread insert is screwed in the threaded hole, the annular thread insert is formed with a threaded hole to be engaged with an end of the shock absorber.

8. The control structure for a shock absorber as claimed in claim 1, wherein a connecting member is disposed at a side of the control member of the control assembly, the connecting member is formed with a connecting hole for accommodation of a connecting shaft, the pushing member of the moving assembly is formed with a connecting hole for engaging with the connecting shaft of the control member, the control member controls the motion of the pushing member.

9. The control structure for a shock absorber as claimed in claim 1, wherein the control assembly and the moving assembly are installed on the based, the control assembly controls the moving assembly;
the control assembly includes a control member and a returning spring, a side of the control member is connected to a steel cable, the returning spring provides an elastic force for returning relative components to their original positions;
the moving assembly includes a positing member, a pushing member, a mounting member, a first sliding member, and a second sliding member, the pushing member is located between the positioning member and the mounting member, the positioning member is formed with a slope that is located correspondingly to the pushing member, the slope includes a deep portion and a shallow portion;
the pushing member is received between the positioning member and the mounting member, a first receiving groove is formed in the pushing member and is located correspondingly to the slope of the positioning member, an abutting surface is formed at the bottom of the first receiving groove, a second receiving groove is formed in the pushing member and is located correspondingly to the slope of the mounting member, an abutting surface is formed at the bottom of the second receiving groove;
the first sliding member is received in the first receiving groove of the pushing member in such a manner that one end of the first sliding member abuts against the abutting surface of the receiving groove, and the other end of the first sliding member abuts against the slope of the positioning member;
the second sliding member is received in the second receiving groove of the pushing member in such a manner that one end of the second sliding member abuts against the abutting surface of the receiving groove, and the other end of the second sliding member abuts against the slope of the pushing rod, when the control assembly drives the pushing member to move, the first sliding member and the second sliding member will move between the deep portion and the shallow portion of the first slope and the second slope.

10. The control structure for a shock absorber as claimed in claim 9, wherein the positioning member is formed with a groove portion having a groove, an engaging portion is formed on the outer surface of the mounting member and is to be slideably received in the groove of the groove portion, the engaging portion of the mounting member is formed with a receiving groove in which being received assistant sliding members, the assistant sliding members are employed to roll within the groove of the positioning member, allowing the engaging portion of the mounting member to slide more smoothly in the groove of the positioning member.

11. The control structure for a shock absorber as claimed in claim 1, wherein the control assembly and the moving assembly are installed on the based, the control assembly controls the moving assembly;
the control assembly includes a control member and a returning spring, a side of the control member is connected to a steel cable, the returning spring provides an elastic force for returning relative components to their original positions;
the moving assembly includes a positing member, a pushing member, a mounting member, a first sliding member, and a second sliding member, the pushing member is located between the positioning member and the mounting member, the positioning member is formed with a receiving groove, an abutting surface is formed at the bottom of the receiving groove, the pushing member is formed with a slope that is located correspondingly to the receiving groove of the positioning member, the slope includes a deep portion and a shallow portion, the mounting member is formed with a receiving groove, and an abutting surface is formed at the bottom of the receiving groove of the mounting member, the pushing member is formed with a slope that is located correspondingly to the receiving groove of the mounting member, the slope includes a deep portion and a shallow portion;
the first sliding member is received in the receiving groove of the positioning member in such a manner that one end of the first sliding member abuts against the abutting surface of the receiving groove, and the other end of the first sliding member abuts against the first slope of the pushing member;
the second sliding member is received in the receiving groove of the mounting member in such a manner that one end of the second sliding member abuts against the abutting surface of the receiving groove, and the other end of the second sliding member abuts against the second slope of the pushing rod, when the control assembly drives the pushing member to move, the first sliding member and the second sliding member will move between the deep portion and the shallow portion of the first slope and the second slope.

12. The control structure for a shock absorber as claimed in claim 1, wherein the mounting member is formed with a receiving space for reception of the control assembly, a positioning hole and a control hole are formed in the receiving space, a plurality of inner threads is formed in the control hole and is located close to the outer end thereof, a frictional thread insert is meshed with the inner threads and is formed with a step hole and a positioning surface, the positioning surface and the step hole of the frictional thread insert are provided for positioning the control member of the control assembly.

13. The control structure for a shock absorber as claimed in claim 12, wherein the control assembly is further provided with a drive member, a positioning hole is formed in the drive member for accommodation of a positioning shaft, the drive member is pivotally fixed in the receiving space of the base of the shock absorber by the positioning shaft, a first drive shaft and a second drive shaft are disposed beside the positioning hole of the drive member, a through hole is formed in the first drive shaft for insertion of the steel cable, a threaded hole is formed beside the through hole, a positioning screw is screwed in the threaded hole for fixing the steel cable, the second drive shaft is formed with a through hole;
the control member is formed on its outer surface with a step outer diameter consisted of a first outer diameter, a second outer diameter, and a third outer diameter, the first and third outer diameters are slideably inserted in the stepped hole of the frictional thread insert of the base, the first outer diameter of the control member is inserted in the through hole of the second drive shaft;
the returning spring is mounted on the second outer diameter and is biased between the positioning surface of the frictional thread insert and the connecting portion between the second outer diameter and the third outer diameter.

14. The control structure for a shock absorber as claimed in claim 1, wherein the base is dispose at the end of the shock absorber, the control assembly is installed on the base, the base is formed with a threaded hole, an inner hole is formed in the bottom of the threaded hole, a positioning surface is form at the bottom of the inner hole, a receiving space is formed beside the threaded hole for accommodation of returning spring, a positioning nut is screwed in the threaded hole of the base and is formed with a through hole for insertion of a control member, a working space is formed in another side of the base opposite the inner hole, a through hole in communication with the inner hole is formed in the working space for reception of the control member.

15. The control structure for a shock absorber as claimed in claim 14, wherein:
the base is provided with the control assembly;
the control assembly includes drive member, control member and returning spring;
a drive hole is formed in the drive member, a drive shaft is disposed beside the drive hole and is formed with a through hole for insertion of steel cable;
a first drive outer diameter formed at one end of the control member is inserted in the drive hole of the drive member, the control member is connected to the drive member;
a first step portion is formed beside the first drive outer diameter of the control member, beside the first step portion is formed a flange, a second step portion is formed beside the flange, a connecting portion between the flange and the second step portion is a positioning surface, and located beside the second step portion is a second drive outer diameter;
the first step portion of the control member is slideably inserted in the through hole of the positioning nut of the base in such a manner that the flange is slideably received in the inner hole of the base, and the positioning surface of the flange slideably abuts against the positioning surface at the bottom of the inner hole, another side of the flange moveably rests on an end surface of the positioning nut, so that the control member is rotatably but immovably confined in the base, the second step portion is slideably disposed in the through hole of the base;
the returning spring is received in the receiving space of the base in such a manner that one end of the returning spring is inserted in an inserting hole of the base, and the other end is inserted in an inserting of the drive member.

16. The control structure for a shock absorber as claimed in claim 1, wherein:
the control assembly and the moving assembly are installed on the base, and the control assembly controls the moving assembly;
the control assembly includes a drive member, a control member, and a returning spring, the drive member is formed with a drive hole, the control member is formed at one end thereof with a first drive outer diameter to be inserted in the drive hole of the drive member, a second drive outer diameter is formed at another end of the control member;
the moving assembly includes a positioning member, a pushing member, a mounting member, a first sliding member, and a second sliding member, the pushing member is located between the mounting member and the positioning member, the positioning member is formed with a receiving groove, an abutting surface is formed at the bottom of the receiving groove, the pushing member is formed with a first slope which is located correspondingly to the receiving groove of the positioning member, the first slope includes a deep portion and a shallow portion, the mounting member is formed with a receiving groove, an abutting surface is formed at the bottom of the receiving groove of the mounting member, a second slope having a deep portion and a shallow portion is formed in the pushing member and is located correspondingly to the receiving groove of the mounting member, the pushing member is formed with a drive hole, the second driven outer diameter of the control member is inserted in the drive hole of the pushing member, the control member drives the pushing member to move;
the first sliding member is received in the receiving groove of the positioning member in such a manner that one end of the first sliding member abuts against the abutting surface of the receiving groove and the other abuts against the first slope of the pushing member;
the second sliding member is received in the receiving groove of the mounting member in such a manner that one end of the second sliding member abuts against the abutting surface of the receiving groove thereof, and the other end abuts against the second slope of the pushing member, the control member of the control assembly drives the pushing member to move, the first sliding member and the second sliding member move between the deep portion and the shallow portion of the first slope and the second slope.

17. The control structure for a shock absorber as claimed in claim 1, wherein:
the control assembly and the moving assembly are installed on the base, and the control assembly controls the moving assembly;
the control assembly includes a drive member, a control member, and a returning spring, the drive member is formed with a drive hole, the control member is formed at one end thereof with a first drive outer diameter to be inserted in the drive hole of the drive member, a second drive outer diameter is formed at another end of the control member;
the moving assembly includes a positioning member, a pushing member, a mounting member, a first sliding member, and a second sliding member, the pushing member is located between the mounting member and the positioning member, the positioning member is formed with a slope which includes a deep portion and a shallow portion, the pushing member is formed with a first receiving groove located correspondingly to the slope of the positioning member, an abutting surface is formed at the bottom of the first receiving groove, the mounting member is formed with a slope that includes a deep portion and a shallow portion, the pushing member is formed with a second receiving groove located correspondingly to the slope of the mounting member, an abutting surface is formed at the bottom of the second receiving groove, the pushing member is formed with a drive hole, the second drive outer diameter of the control member is inserted in the drive hole of the pushing member, the pushing member is driven to move by the control member;
the first sliding member is slideably received in the first receiving groove of the pushing member in such a manner that one end of the first sliding member abuts against the abutting surface of the first received groove, and the other end abuts against the slope of the positioning member;
the second sliding member is slideably received in the second groove of the pushing member in such a manner that one end of the second sliding member abuts against the abutting surface of the second receiving groove, and the other end abuts against the slope of the mounting member, the control member of the control assembly drives the pushing member to move, the first sliding member and the second sliding member move between the deep portion and the shallow portion of the slope of the mounting member and the positioning member.

18. The control structure for a shock absorber as claimed in claim 1, wherein the base is formed with a working space for accommodation of the moving assembly, the moving assembly includes a positioning assembly, a pushing member, a mounting member, a first sliding member, and a second sliding member, the positioning assembly includes a first positioning member and a second positioning member;
the first positioning member is received in the working space of the base and abuts against the bottom of the working space, a receiving groove is formed in the first positioning member, an abutting surface is formed at the bottom of the receiving groove, a positioning hole is formed in the first positioning member;
the second positioning member is located beside the first positioning member and is formed with a receiving hole and a positioning protrusion to be inserted in the positioning hole of the first positioning member, the first positioning member is connected to the second positioning member.

19. The control structure for a shock absorber as claimed in claim 1, wherein:
the pushing rod of the shock absorber is formed with an end surface in which being formed a positioning hole;
the base is formed with a working space for accommodation of the moving assembly, the moving assembly includes a positioning member, a pushing member, a mounting assembly, a first sliding member, and a second sliding member, the mounting assembly includes a first mounting member and a second mounting member;
the first mounting member is located beside the pushing member and is formed with a receiving hole and a positioning protrusion;
the second mounting member is disposed beside the first mounting member and is formed with a receiving hole and a positioning hole, the positioning protrusion of the first mounting member is inserted through the positioning hole of the second mounting member and the positioning hole of the pushing rod, so that the first mounting member, the second mounting member and the pushing rod are connected together.

20. The control structure for a shock absorber as claimed in claim 1, wherein the base is formed with a working space for accommodation of the moving assembly, the moving assembly includes a positioning member, a pushing member, a mounting assembly, a first sliding member and a second sliding member, the mounting assembly includes a first mounting member, a second mounting member, and a third mounting member;
the first mounting member is located beside the pushing member and is formed with a receiving hole and a positioning protrusion;
the second mounting member is located beside the first mounting member and is formed with a receiving hole and a positioning hole;
the third mounting member is located beside the second mounting member and is formed with an abutting surface and a positioning hole;
the positioning protrusion of the first mounting member is inserted in the positioning hole of the second mounting member and is fixed in the positioning hole of the third mounting member, the first mounting member, the second mounting member, and the third mounting member connected.
